(19) United States
(12) Patent Application Publication
(10) Pub. No.: US 2026/0016875 A1
(43) Pub. Date: Jan. 15, 2026

(54) MANAGING OVERCURRENT PROTECTION FOR PERIPHERAL DEVICES

(71) Applicant: Aivres Systems Inc., San Jose, CA (US)

(72) Inventor: Zimin HONG, New Taipei City (TW)

(21) Appl. No.: 19/333,739

(22) Filed: Sep. 19, 2025

(51) Int. Cl. G06F 1/30; G06F 1/26; G06F 13/40; H02H 3/00; H02H 3/087

(52) U.S. Cl. CPC G06F 1/30; G06F 1/266; G06F 13/4068; H02H 3/006; H02H 3/087; G06F 2213/0026

(57) ABSTRACT

Methods, devices, subsystems, systems, and techniques for managing overcurrent protections for peripheral devices are provided. An example device includes: one or more connectors configurable to connect one or more peripheral devices having one or more corresponding power requirements; a power protection circuit configured to provide overcurrent protection to a peripheral device connected to the device; and a resistance circuit configured to provide to the power protection circuit an adjustable resistance based on one or more sense signals from the one or more connectors. The one or more sense signals are based on a connection status between the one or more connectors and the peripheral device, and the one or more sense signals indicate a corresponding power requirement of the peripheral device. The power protection circuit is configured to stop providing power to the peripheral device based on the adjustable resistance and a sensed current associated with the peripheral device.

### TECHNICAL FIELD

The present disclosure is related to computing devices.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external or peripheral devices within the same server chassis, making the computing devices suitable for a variety of applications.

### SUMMARY

The present disclosure describes methods, devices, systems and techniques for managing overcurrent protection for peripheral devices, e.g., Peripheral Component Interconnect Express (PCIe) devices.

One aspect of the present disclosure features a device, including: one or more connectors configurable to connect one or more peripheral devices that have one or more corresponding power requirements; a power protection circuit configured to provide overcurrent protection to a peripheral device that is connected to the device; and a resistance circuit connected to the power protection circuit, where the resistance circuit is configured to provide to the power protection circuit an adjustable resistance based on one or more sense signals from the one or more connectors. The one or more sense signals are based on a connection status between the one or more connectors and the peripheral device, and the one or more sense signals indicate a corresponding power requirement of the peripheral device. The power protection circuit is configured to stop providing power to the peripheral device based on the adjustable resistance and a sensed current associated with the peripheral device.

In some implementations, the power protection circuit is configured to: perform a comparison between a first voltage determined based on the sensed current and a constant resistor and a second voltage determined based on the adjustable resistance and a constant current; and determine to stop providing the power to the peripheral device based on a result of the comparison.

In some implementations, the power protection circuit includes a comparator and a power switch. The power switch includes an input configured to be controlled by an output of the comparator and an output coupled to the peripheral device. The power protection circuit is configured to: determine, using the comparator, whether the first voltage is greater than the second voltage; and in response to determining that the first voltage is greater than the second voltage, turn off the power switch, causing to stop providing the power to the peripheral device.

In some implementations, the power protection circuit further includes a control transistor having a first terminal coupled to the input of the power switch, a second terminal coupled to a ground reference voltage, and a gate terminal coupled to the output of the comparator. The control transistor is configured to be turned on in response to the first voltage being greater than the second voltage, causing to turn off the power switch.

In some implementations, the power protection circuit is configured to: in response to determining that the first voltage is no greater than the second voltage, turn on the power switch, causing to provide the power to the peripheral device.

In some implementations, the power protection circuit includes a control logic circuit configured to generate the sensed current based on at least one of a current in the peripheral device, a type of the peripheral device, or the power requirement of the peripheral device.

In some implementations, the resistance circuit includes: a plurality of resistors each coupled between an input of the power protection circuit and a ground reference voltage, where an output of the power protection circuit is coupled to the peripheral device and the one or more connectors; and one or more transistors, where each transistor of the one or more transistors is coupled in series with a respective resistor of the plurality of resistors between the input of the power protection circuit and the ground reference voltage, and configured to be turned on or off based on at least a corresponding sense signal of the one or more sense signals from the one or more connectors.

In some implementations, the peripheral device is connected with each of the one or more connectors, causing each of the one or more sense signals to have a lower voltage level to turn off the one or more transistors in the resistance circuit, such that the adjustable resistance for the peripheral device is based on at least one remaining resistor in the resistance circuit, independent from one or more resistors coupled in series with the one or more transistors.

In some implementations, the peripheral device is configured to have a power requirement of 300 W.

In some implementations, the peripheral device includes power pins coupled to pins of an interface of the device that are coupled to the output of the power protection circuit, the interface being different from the one or more connectors, and the device is configured to provide a corresponding power to the peripheral device through the power pins and the one or more connectors.

In some implementations, the peripheral device includes one or more power connectors corresponding to the one or more connectors, each of the one or more power connectors being connected to a respective connector of the one or more connectors through a corresponding power cable.

In some implementations, the peripheral device is disconnected from at least one of the one or more connectors, causing at least one sense signal of the one or more sense signals to have a higher voltage level to turn on at least one corresponding transistor in the resistance circuit, such that the adjustable resistance for the peripheral device is based on at least one resistor coupled in series with the at least one corresponding transistor.

In some implementations, the peripheral device is configured to have a power requirement of 225 W or 150 W.

In some implementations, the peripheral device includes power pins coupled to pins of an interface of the device that are coupled to the output of the power protection circuit, the interface being different from the one or more connectors, and the device is configured to provide a corresponding power to the peripheral device through the power pins and at least one remaining connector of the one or more connectors that is connected to the peripheral device.

In some implementations, the peripheral device includes at least one power connector configured to be connected to the at least one remaining connector through at least one corresponding power cable.

In some implementations, the peripheral device is disconnected from each of the one or more connectors, causing the one or more sense signals to have a higher voltage level to turn on the one or more transistors, such that the adjustable resistance for the peripheral device is based on at least one or more resistors coupled in series with the one or more transistors.

In some implementations, the peripheral device is configured to have a power requirement of 75 W.

In some implementations, the peripheral device includes power pins coupled to pins of an interface of the device that are coupled to the output of the power protection circuit, the interface being different from the one or more connectors.

In some implementations, the peripheral device includes no power connector corresponding to the one or more connectors.

In some implementations, the one or more connectors include: a first connector having at least one first node configured to provide at least one first sense signal, and a second connector having at least one second node configured to provide at least one second sense signal. Each node of the at least one first node and the at least one second node is coupled to a corresponding transistor of the one or more transistors and configured to provide a respective sense signal to the corresponding transistor.

In some implementations, the device further includes a logic gate having inputs coupled to at least two nodes of the at least one first node and the at least one second node and an output coupled to a particular transistor of the one or more transistors.

In some implementations, the device further includes a control logic coupled between the one or more connectors and the resistance circuit and configured to provide the one or more sense signals respectively to the one or more transistors.

In some implementations, the control logic includes a Complex Programmable Logic Device (CPLD).

In some implementations, the peripheral device includes: power pins coupled to the output of the power protection circuit.

In some implementations, the peripheral device further includes: a first power connector configurable to connect to the first connector of the one or more connectors.

In some implementations, the peripheral device further includes a second power connector configurable to connect to the second connector of the one or more connectors.

In some implementations, the peripheral device further includes: power pins coupled to at least one of the first connector or the second connector.

In some implementations, the peripheral device is configured to have a power requirement of 80 W or 150 W.

In some implementations, a number of the plurality of resistors is greater than a number of the one or more transistors.

In some implementations, the one or more peripheral devices include a PCIe device, and the one or more connectors include a PCIe connector.

In some implementations, the power protection circuit include an electronic fuse (eFuse) circuit.

In some implementations, the one or more peripheral devices include an Open Compute Project (OCP) device having gold finger pins, and where the one or more connectors include a gold finger connector.

Another aspect of the present disclosure features a system, including: a host device; and a peripheral device. The host device includes: one or more connectors configurable to connect one or more peripheral devices that have one or more corresponding power requirements; a power protection circuit configured to provide overcurrent protection to the peripheral device that is connected to the host device; and a resistance circuit connected to the power protection circuit, where the resistance circuit is configured to provide to the power protection circuit an adjustable resistance based on one or more sense signals from the one or more connectors. The one or more sense signals are based on a connection status between the one or more connectors and the peripheral device, and the one or more sense signals indicate a corresponding power requirement of the peripheral device, and the power protection circuit is configured to stop providing power to the peripheral device based on the adjustable resistance and a sensed current associated with the peripheral device.

In some implementations, the host device includes a computing circuit coupled to the power protection circuit and configured to control the power protection circuit.

In some implementations, the computing circuit includes at least one of a processing unit, a Base Board Management Controller (BMC), a Complex Programmable Logic Device (CPLD), or a power supply source.

In some implementations, the power protection circuit includes a first input coupled to the CPLD for receiving a control signal and a second input coupled to the power supply source for receiving an input voltage.

Another aspect of the present disclosure features a method, including: determining a sensed current associated with a peripheral device coupled to an output of a power protection circuit; comparing a first voltage based on the sensed current and a second voltage based on an adjustable resistance of a resistance circuit to generate a comparison result, where the resistance circuit is coupled to an input of the power protection circuit; and determining whether to stop providing power to the peripheral device based on the comparison result. The adjustable resistance is based on one or more sense signals from one or more connectors coupled to the output of the power protection circuit. The one or more connectors are configurable to be connected to the peripheral device according to a power requirement of the peripheral device, and the one or more sense signals are based on a connection status between the one or more connectors and the peripheral device, and indicate the power requirement of the peripheral device.

In some implementations, the power protection circuit includes a comparator and a power switch. The power switch includes an input configured to be controlled by an output of the comparator and an output coupled to the peripheral device. Determining whether to stop providing power to the peripheral device based on the comparison result includes: determining, using the comparator, whether the first voltage is greater than the second voltage; and in response to determining that the first voltage is greater than the second voltage, turning off the power switch, causing to stop providing the power to the peripheral device.

In some implementations, the power protection circuit further includes a control transistor having a first terminal coupled to the input of the power switch, a second terminal coupled to a ground reference voltage, and a gate terminal coupled to the output of the comparator. Determining whether to stop providing power to the peripheral device based on the comparison result includes: in response to the first voltage being greater than the second voltage, turning on the control transistor, causing to turn off the power switch.

In some implementations, determining whether to stop providing power to the peripheral device based on the comparison result includes: in response to determining that the first voltage is no greater than the second voltage, turning on the power switch, causing to provide the power to the peripheral device.

In some implementations, determining the sensed current associated with the peripheral device coupled to the output of the power protection circuit includes: generating the sensed current based on at least one of a current in the peripheral device, a type of the peripheral device, or the power requirement of the peripheral device.

In some implementations, the resistance circuit includes: a plurality of resistors each coupled between an input of the power protection circuit and a ground reference voltage, where an output of the power protection circuit is coupled to the peripheral device and the one or more connectors; and one or more transistors. Each transistor of the one or more transistors is coupled in series with a respective resistor of the plurality of resistors between the input of the power protection circuit and the ground reference voltage, and configured to be turned on or off based on at least a corresponding sense signal of the one or more sense signals from the one or more connectors.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 illustrates an example computing system for overcurrent protection for peripheral devices.

FIG. 2A is an example of a computing device configured to provide overcurrent protection for a peripheral device with a 300 W power requirement.

FIG. 2B is an example of a computing device configured to provide overcurrent protection for a peripheral device with a 225 W power requirement.

FIG. 2C is an example of a computing device configured to provide overcurrent protection for a peripheral device with a 150 W power requirement.

FIG. 2D is an example of a computing device configured to provide overcurrent protection for a peripheral device with a 75 W power requirement.

FIG. 3A is an example of a computing system including a computing device configured to provide overcurrent protection for an OCP device with an 80 W power requirement.

FIG. 3B is an example of a computing system including a computing device configured to provide overcurrent protection for an OCP device with an 150 W power requirement.

FIG. 4 is a flowchart of an example process of a method of managing overcurrent protection for a peripheral device.

FIG. 5 illustrates an example computing device.

FIG. 6 illustrates an example computing system.

Like reference numbers and designations in the various drawings indicate like elements.

### DETAILED DESCRIPTION

Implementations of the present disclosure provide methods, devices, systems and techniques for managing overcurrent protection for peripheral devices, e.g., PCIe devices. A device, e.g., a host device, can use a power protection circuit to provide protection to a peripheral device that is connected to the device. In some implementations, a power protection circuit can be an integrated circuit (IC) that can be used to protect a motherboard and connected peripheral devices, e.g., PCIe devices, from power related damages. For example, a power protection circuit, such as an electronic fuse (eFuse), can provide overcurrent, overvoltage, or overtemperature protection for electronic circuits.

In some implementations, the power protection circuit can protect the peripheral device from current or voltage surges caused by hot plugging. In some implementations, the power protection circuit can protect the peripheral device from overcurrent. For example, the power protection circuit can protect a PCIe device from overcurrent due to excessive current consumption or excessive overload of a power IC, e.g., when the PCIe device starts up abnormally. In some implementations, the power protection circuit can protect the peripheral device from unstable voltage and can prevent damages to the IC inside the peripheral device. In some implementations, the power protection circuit can protect the peripheral device from Electrostatic Discharge (ESD), such as preventing damages caused by static electricity.

Peripheral devices can have a wide range of power requirements. For example, power requirements of PCIe devices can range from 600 W to 75 W. Some peripheral devices can have a fixed voltage, such as 12V or 3.3V. Thus, the output current provided by a device to peripheral devices connected to the device can change when the power requirements of the peripheral devices change. Because peripheral devices can have a wide range of power requirements, a power protection circuit configured to protect a first peripheral device may not provide complete protection for a second peripheral device that has a different power requirement from the power requirement of the first peripheral device. For example, a power protection circuit configured to provide overcurrent protection for a 300 W PCIe device cannot provide complete overcurrent protection for another PCIe device that has a power requirement that is below 300 W.

For example, for a 300 W PCIe device operating at 12V voltage, the rated current can be approximately 300 W/12V=25 A. The overcurrent protection setting can be 25 A×1.5=37.5 A. Here, 1.5 is an example value for a constant factor for overcurrent protection setting. If the current generated from the PCIe device is greater than 37.5 A, the power protection circuit can stop providing power to the PCIe device, thus providing overcurrent protection. However, if the power protection circuit uses the same overcurrent protection setting for peripheral devices with different power requirements, the power protection circuit may not provide sufficient overcurrent protection for some peripheral devices. For example, when the peripheral device is a 75 W device, a suitable overcurrent protection setting should be 75 W/12V×1.5=9.375 A. If the power protection circuit uses the same 37.5 A setting for both the 75 W and the 300 W devices, the power protection circuit cannot stop providing power to the 75 W device, even when the current generated in the 75 W device is greater than 9.375 A but is no greater than 37.5 A.

The systems and techniques can manage overcurrent protection for peripheral devices with a wide range of power requirements. The systems and techniques can provide overcurrent protection to both higher and lower wattage peripheral devices. The systems and techniques are related to a resistance circuit that is connected to a power protection circuit. The resistance circuit is configured to provide to the power protection circuit an adjustable resistance based on a corresponding power requirement of a peripheral device. The power protection circuit is configured to stop providing power to the peripheral device based on the adjustable resistance and a sensed current associated with the peripheral device.

The subject matter described in this specification can be implemented to realize one or more of the following technical advantages, effects and/or benefits. The systems and techniques described can adapt an overcurrent limit setting in the power protection circuit to the different power requirements of different peripheral devices. In some implementations, the systems and techniques described can improve the overcurrent protection for peripheral devices with a lower power requirement, e.g., low-wattage PCIe devices. In some implementations, the systems and techniques described can provide overcurrent protection for peripheral devices with both higher power requirements and lower power requirements, e.g., higher-wattage and lower-wattage PCIe devices.

In some implementations, the systems and techniques described herein can use one or more sense signals obtained from one or more power connectors for the peripheral device to detect the power requirement of the peripheral device. In some implementations, the systems and techniques described can configure an adjustable resistance of a resistance circuit based on the one or more sense signals. In some implementations, the systems and techniques can change an overcurrent limit setting of the power protection circuit according to the adjustable resistance, thus achieving overcurrent protection for peripheral devices with a wide range of power requirements.

The techniques can be implemented for any suitable power control, and can be implemented for any suitable protocol, e.g., Serial Advanced Technology Attachment (SATA) protocol, or Peripheral Component Interconnect Express (PCIe) protocol, or Ultra Path Interconnect (UPI) protocol, or Open Compute Project (OCP) protocol. The techniques can be implemented for any suitable PCIe technologies, e.g., PCIe Gen 3, PCIe Gen 4, PCIe Gen 5, PCIe Gen 6.0, or even higher PCIe version.

The following detailed description is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

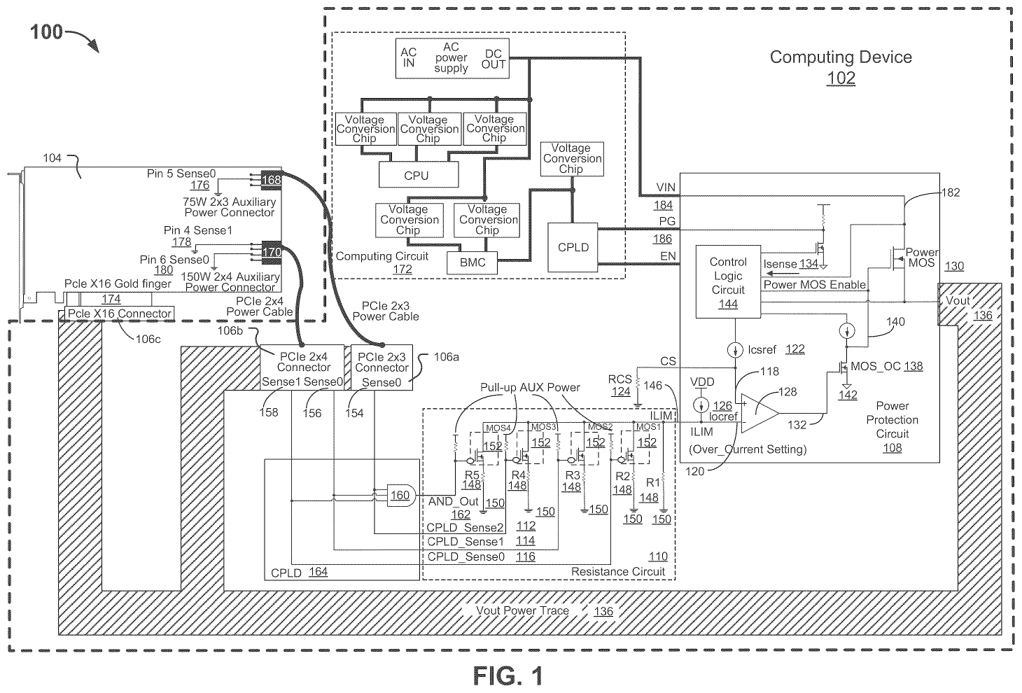

FIG. 1 illustrates an example computing system 100 including a computing device 102 configured to provide overcurrent protection for a peripheral device 104. In some implementations, the computing device 102 can be a host device that provides resources and/or services to one or more other devices, such as the peripheral device 104.

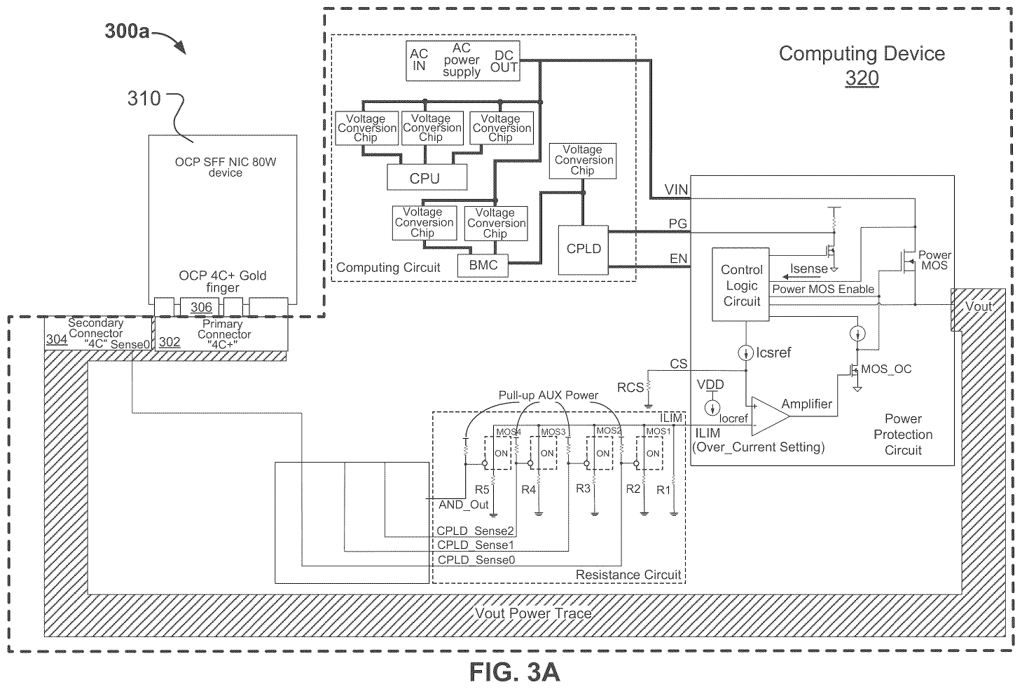

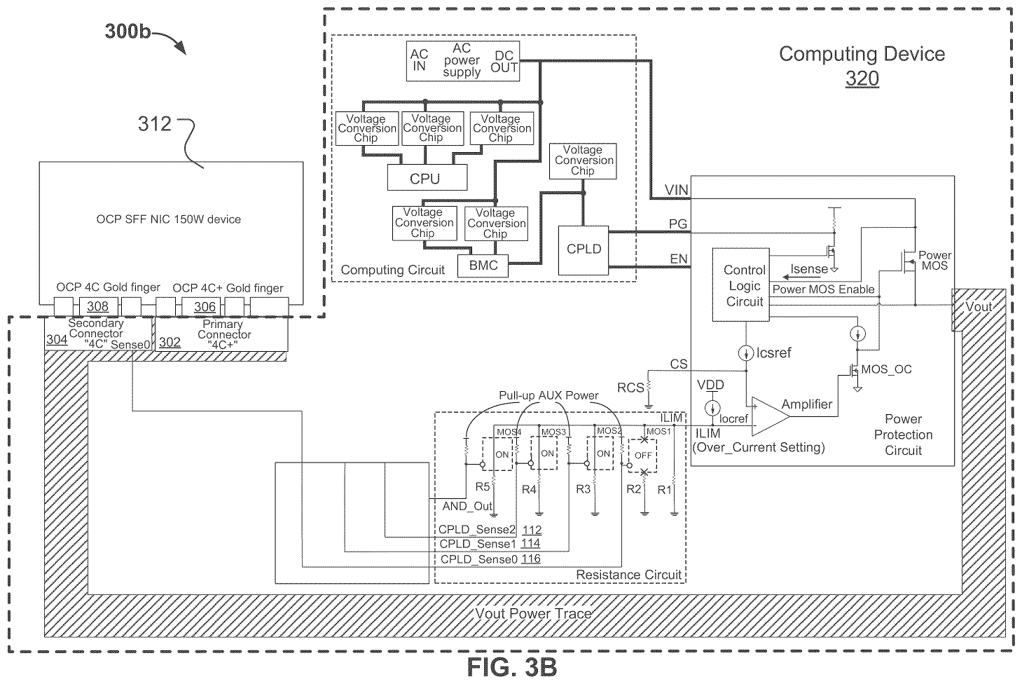

The peripheral device 104 can be an external device connected to the computing device 102. In some implementations, the peripheral device 104 can be used to enhance the functionality of the computing device 102. In some implementations, the peripheral device 104 can be a PCIe device that connects to a motherboard of the computing device 102 using the PCIe protocol for high-speed data transfer. An example of a PCIe device can includes a Graphics Processing Unit (GPU), a sound device, a capture device, an expansion device, a graphic card, a network device such as a network interface card, a storage device, or a storage controller for one or more storage devices. In some implementations, the peripheral device 104 can be an Open Compute Project (OCP) device, as described in connection with FIGS. 3A-3B.

The computing device 102 can include one or more connectors 106a and 106b (referred to generally as connectors 106 and individually as connector 106). The one or more connectors 106 are configurable to connect one or more peripheral devices. For example, the computing device 102 can include a PCIe 2×3 connector 106a. Note that the notation “2×3” refers to the PCIe connector's physical configuration or pin arrangement, indicating it has: 2 rows, 3 columns of pins. Therefore, a 2×3 PCIe connector has a total of 6 pins. The PCIe 2×3 connector 106a can be configurable to connect to a PCIe device 104. The PCIe 2×3 connector 106a can connect to a 2×3 auxiliary power connector 168 of the PCIe device 104 using a PCIe 2×3 power cable. For example, the computing device 102 can include a PCIe 2×4 connector 106b (e.g., having 2 row an 4 columns of pins with a total of 8 pins). The PCIe 2×4 connector 106b can be configurable to connect to a PCIe device 104. The PCIe 2×4 connector 106b can connect to a 2×4 auxiliary power connector 170 of the PCIe device 104 using a PCIe 2×4 power cable. In some implementations, the peripheral device 104 can include power pins, such as the PCIe gold finger 174, coupled to a PCIe ×16 connector 106c of the computing device 102. Note that “×16” the “×16” signifies that the slot has 16 data lanes.

Different peripheral devices can have different power requirements. The one or more connectors 106 are configurable to connect one or more peripheral devices having one or more corresponding power requirements. In some implementations, a PCIe device with a higher power requirement may need additional auxiliary power sources, one or more power pins, or a combination of both, to achieve the required power. Table 1 shows example power sources for PCIe devices with different power requirements.

TABLE 1
Example power sources for PCIe devices
with different power requirements

| PCIe device power source | 300 W | 225 W | 150 W | 75 W |
|---|---|---|---|---|
| PCIe x16 gold finger up to 75 W | Yes | Yes | Yes | Yes |
| 2 × 4 auxiliary power connector | Yes | Yes | No | No |
| 150 W | | | | |
| 2 × 3 auxiliary power connector | Yes | No | Yes | No |
| 75 W | | | | |

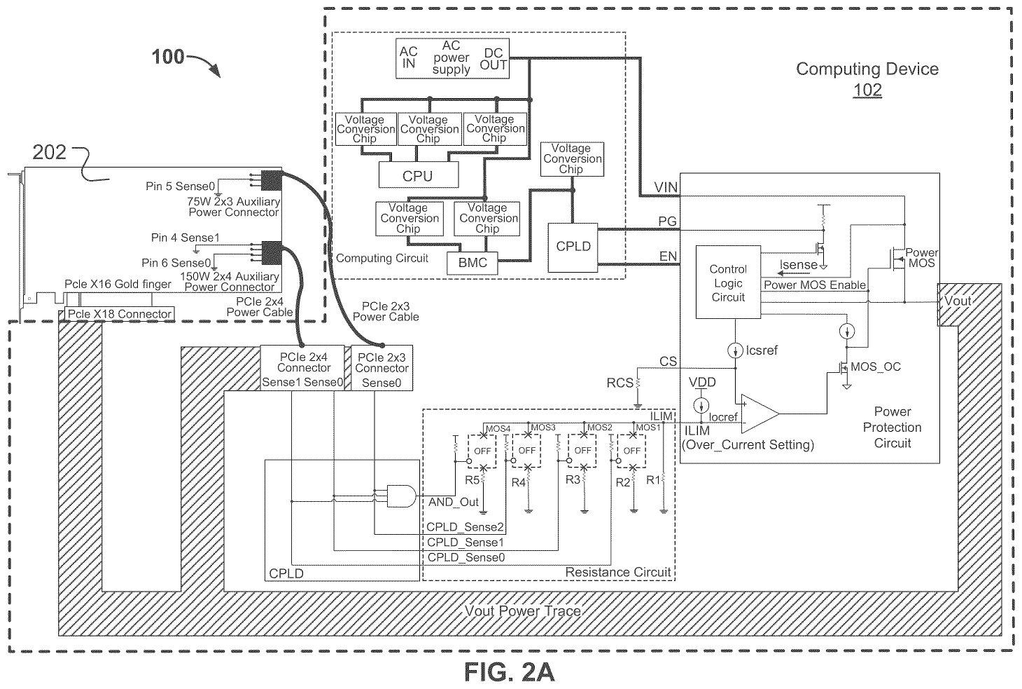

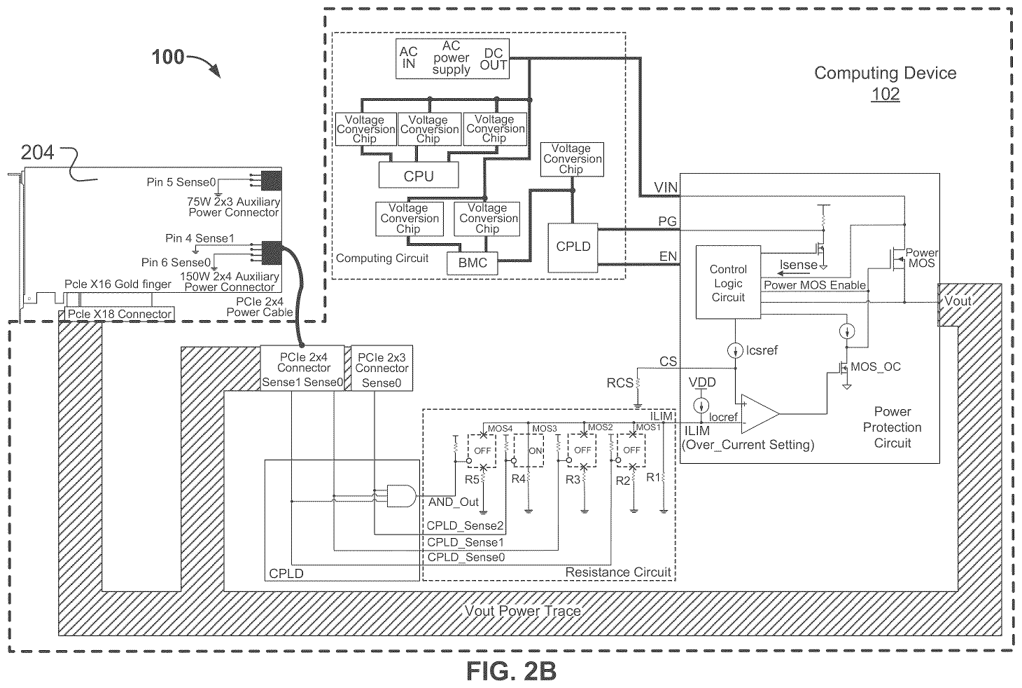

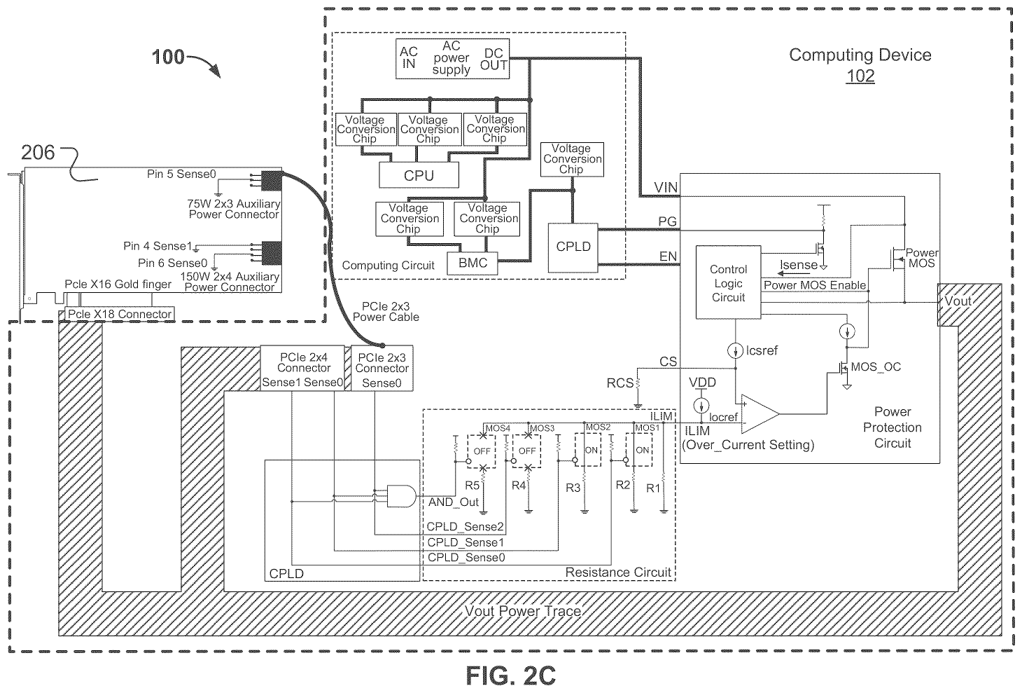

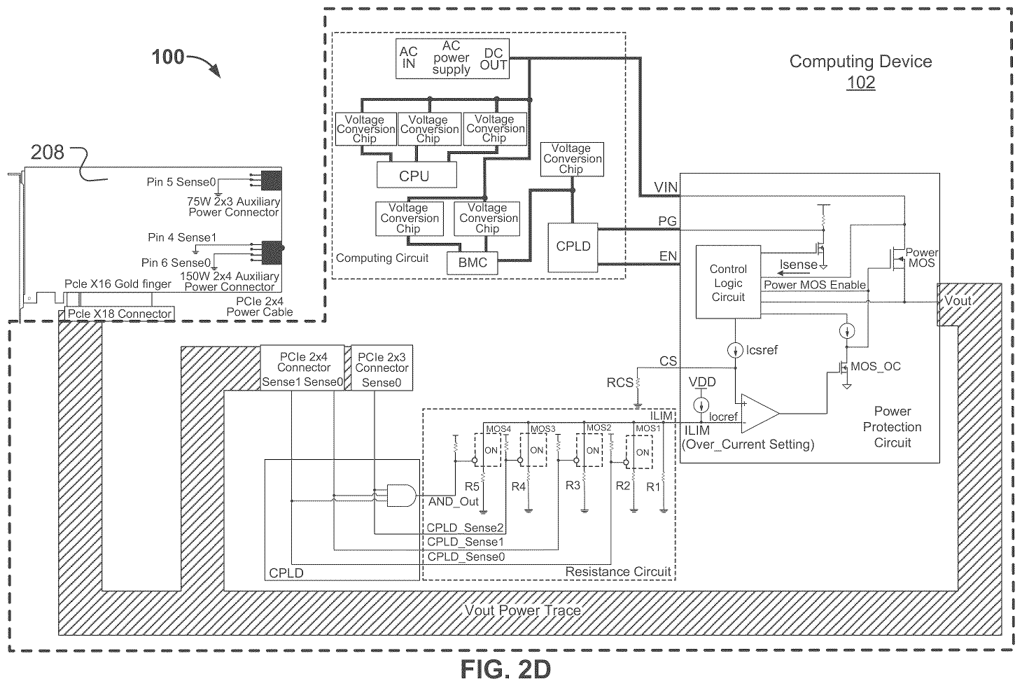

In some implementations, for a PCIe device with a power requirement of less than or equal to 75 W, the computing device 102 can provide power to the PCIe device through the PCIe gold finger 174 included in the PCIe device. FIG. 2D is an example of the computing device 102 configured to provide overcurrent protection for a peripheral device 208 with a 75 W power requirement. The computing device 102 includes a PCIe ×16 connector 106c. The PCIe ×16 connector 106c is connected to the PCIe ×16 gold finger 174 of the PCIe device 104. The PCIe 2×4 connector 106b and the PCIe 2×3 connector 106a are disconnected from the PCIe device 104, e.g., without a connection cable therebetween. The computing device 102 provides the power output Vout 136 through the power pins, e.g., the PCIe gold finger 174, not through the auxiliary power connectors 168 and 170. The PCIe device with the power requirement of less than or equal to 75 W can just include the power pins, without the auxiliary power connectors 168 and 170.

In some implementations, for a PCIe device with a power requirement of 150 W, the computing device 102 can provide power to the PCIe device through the PCIe gold finger 174 and the PCIe 2×3 auxiliary power connector 168 included in the PCIe device. FIG. 2C is an example of the computing device 102 configured to provide overcurrent protection for a peripheral device 206 with a 150 W power requirement. The PCIe ×16 connector 106c is connected to the PCIe ×16 gold finger 174. The PCIe 2×3 connector 106a is connected to the 2×3 auxiliary power connector 168 using the PCIe 2×3 power cable. The PCIe 2×4 connector 106b is disconnected from the PCIe device 104, e.g., without a connection cable connecting the PCIe 2×4 connector 106b and the PCIe device 104. The computing device 102 provides the voltage output 136 through the PCIe gold finger 174 and the 2×3 auxiliary power connector 168, not through the 2×4 auxiliary power connector 170.

In some implementations, for a PCIe device with a power requirement of 225 W, the computing device 102 can provide power to the PCIe device through the PCIe gold finger 174 and the PCIe 2×4 auxiliary power connector 170 included in the PCIe device. FIG. 2B is an example of the computing device 102 configured to provide overcurrent protection for a peripheral device 204 with a 225 W power requirement. The PCIe ×16 connector 106c is connected to the PCIe ×16 gold finger 174. The PCIe 2×4 connector 106b is connected to the 2×4 auxiliary power connector 170 using the PCIe 2×4 power cable. The PCIe 2×3 connector 106a is disconnected from the PCIe device 104. The computing device 102 provides the voltage output 136 through the PCIe gold finger 174 and the 2×4 auxiliary power connector 170, not through the 2×3 auxiliary power connector 168.

In some implementations, for a PCIe device with a power requirement of 300 W, the computing device 102 can provide power to the PCIe device through the PCIe gold finger 174, the PCIe 2×3 auxiliary power connector 168, and the PCIe 2×4 auxiliary power connector 170 included in the PCIe device. FIG. 2A is an example of the computing device 102 configured to provide overcurrent protection for a peripheral device 202 with a 300 W power requirement. The PCIe ×16 connector 106c is connected to the PCIe ×16 gold finger 174. The PCIe 2×4 connector 106b is connected to the 2×4 auxiliary power connector 170 using the PCIe 2×4 power cable. The PCIe 2×3 connector 106a is connected to the 2×3 auxiliary power connector 168 using the PCIe 2×3 power cable. The computing device 102 provides the voltage output 136 through the PCIe gold finger 174, the 2×3 auxiliary power connector 168, and the 2×4 auxiliary power connector 170.

In some implementations, for a PCIe device with a power requirement of 600 W, the computing device 102 can provide power to the PCIe device, e.g., through a PCIe 2×6 auxiliary power connector included in the PCIe device. The systems and techniques described herein can be applied to a PCIe device with a power requirement of 600 W, or any other power requirement.

The computing device 102 includes a power protection circuit 108. The power protection circuit 108 is configured to provide overcurrent protection to the peripheral device 104 that is connected to the computing device 102. In some implementations, the computing device 102 can provide a constant voltage (e.g., 12 V or 3.3 V) to the peripheral device 104. Thus, peripheral devices with different power requirements can generate different amounts of current in the peripheral devices. For peripheral devices with different power requirements, the overcurrent protection setting in the power protection circuit 108 needs to be adjusted. In some cases, the overcurrent protection setting is greater than the rated current of a peripheral device by a constant factor, to provide overcurrent protection for the peripheral device. For example, the constant factor can be between 1.2 to 1.5. That is, the overcurrent protection setting can be 1.2 to 1.5 times greater than the rated current of a peripheral device.

In some examples, the constant factor for overcurrent protection can be 1.5. For a 300 W PCIe device operating at 12V voltage, the rated current can be approximately 300 W/12V=25 A. The overcurrent protection setting can be 25 A×1.5=37.5 A. If the current generated from the PCIe device is greater than 37.5 A, the power protection circuit 108 can be configured to stop providing power to the PCIe device, thus providing overcurrent protection. If the current generated from the PCIe device is not greater than 37.5 A, the power protection circuit 108 can be configured to continue providing power to the PCIe device.

The computing device 102 includes a resistance circuit 110. The resistance circuit 110 is connected to the power protection circuit 108. The resistance circuit 110 is configured to provide to the power protection circuit 108 an adjustable resistance based on one or more sense signals (e.g., 112, 114, and 116). The one or more sense signals (e.g., 112, 114, and 116) can be from the one or more connectors 106.

In some implementations, the one or more connectors 106 can include a first connector 106a having at least one first node 154 configured to provide at least one first sense signal 112. In some implementations, the one or more connectors 106 can include a second connector 106b having one or more second nodes (e.g., 156 and 158) configured to provide one or more second sense signals (e.g., 114 and 116). For example, the PCIe 2×3 connector 106a can have one first node (Sense0) 154 that provides the sense signal 112. The PCIe 2×4 connector 106b can have one second node (Sense0) 156 that provides the sense signal 114 and another one second node (Sense 1) 158 that provides the sense signal 116.

The one or more sense signals 112, 114, and 116 can be based on a connection status between the one or more connectors 106 and the peripheral device 104. For example, the one or more sense signals 112, 114, and 116 can indicate a corresponding power requirement of the peripheral device 104. Table 2 shows an example of one or more sense signals and the corresponding power requirement of the peripheral device 104.

TABLE 2
Sense signals and the corresponding power requirement

| Sense2 | Sense1 | Sense0 | Power(W) |
|---|---|---|---|
| 0 | 0 | 0 | 300 |
| 1 | 0 | 0 | 225 |
| 1 | 1 | 0 | 150 |
| 1 | 1 | 1 | 75 |

For example, when the peripheral device 104 requires 300 W, each of the sense signals 112, 114, and 116 can be at a predetermined voltage level, e.g., a lower voltage level (indicated as 0, 0, 0 in Table 2). When the peripheral device 104 requires 225 W, the sense signal 112 is not at the predetermined voltage level. For example, the sense signal 112 can be at a higher voltage level (indicated as 1 in Table 2). The sense signals 114 and 116 can be at the predetermined voltage level (indicated as 0 and 0). When the peripheral device 104 requires 150 W, the sense signals 112, 114, and 116 can be at the higher voltage level, the higher voltage level, and the lower voltage level, respectively, (indicated as 1, 1, 0). When the peripheral device 104 requires 75 W, each of the sense signals 112, 114, and 116 can be at the higher voltage level (indicated as 1, 1, 1).

In some implementations, the computing device 102, e.g., through the power protection circuit 108, can provide power to the peripheral device 104 through one or more connectors 106. In some implementations, the peripheral device 104 can include power pins, such as the PCIe gold finger 174, coupled to the voltage output 136 of the power protection circuit 108, e.g., through the PCIe ×16 connector 106c. In some implementations, the peripheral device 104 can include one or more power connectors 168 and 170 coupled to the voltage output 136 of the power protection circuit 108, e.g., through the PCIe 2×3 connector 106a or the PCIe 2×4 connector 106b.

In some implementations, the peripheral device 104 can include a first power connector 168 configurable to connect to the first connector 106a of the one or more connectors 106. In some implementations, the peripheral device 104 can include a second power connector 170 configurable to connect to the second connector 106b of the one or more connectors 106. The one or more connectors 106 can provide the one or more sense signals 112, 114, and 116 at different combinations of voltage levels because sense pins of the one or more power connectors included in the peripheral device 104 can have different voltage levels.

For example, the PCIe association defines pins of a 2×3 auxiliary power connector, such as the power connector 168, for a PCIe device. The pins of a 2×3 auxiliary power connector 168 for a PCIe device can include a sense pin 176. The sense pin 176 can be connected to a ground reference voltage, e.g., the predetermined voltage level being a lower voltage level. When the 2×3 auxiliary power connector 168 is connected to the PCIe connector 106a, the node 154 of the connector 106a can obtain its signal from the sense pin 176 of the 2×3 auxiliary power connector 168. Thus, when the 2×3 auxiliary power connector 168 is connected to the PCIe connector 106a, the sense signal 112 is at the predetermined voltage level, e.g., the lower voltage level of the ground reference voltage. When the 2×3 auxiliary power connector 168 is not connected to the PCIe connector 106a, the sense signal 112 is not at the predetermined voltage level.

For example, the PCIe association defines pins of a 2×4 auxiliary power connector, such as the power connector 170, for a PCIe device. The pins of a 2×4 auxiliary power connector 170 for a PCIe device can include a first sense pin 178 and a second sense pin 180. The sense pins 178 and 180 can each be connected to a ground reference voltage, e.g., the predetermined voltage level being the lower voltage level. When the 2×4 auxiliary power connector 170 is connected to the PCIe connector 106b, the node 156 of the connector 106b can obtain its signal from the sense pin 178 of the 2×4 auxiliary power connector 170, and the node 158 of the connector 106b can obtain its signal from the sense pin 180 of the 2×4 auxiliary power connector 170. Thus, when the 2×4 auxiliary power connector 170 is connected to the PCIe connector 106a, the sense signals 114 and 116 are both at the predetermined voltage level, e.g., the lower voltage level of the ground reference voltage. When the 2×4 auxiliary power connector 170 is not connected to the PCIe connector 106a, the sense signals 114 and 116 are both not at the predetermined voltage level.

In some implementations, the computing device 102 can include a computing circuit 172. In some implementations, the computing circuit 172 can use an X86 architecture, or another other computer architecture. The computing circuit 172 can receive an input power and can provide an output power, such as a 12V or 3.3V voltage. For example, the computing circuit 172 can receive an alternating current (AC) input from an AC power supply. The computing circuit 172 can output a direct current (DC) output, such as a 12V or 3.3V voltage. The DC output can be the system power of the computing device 102. The computing circuit 172 can provide the system power as an input (e.g., VIN 184) to the power protection circuit 108. For example, the power protection circuit 108 can have a VIN pin that receives the system power (such as a 12V or 3.3V voltage) from the computing circuit 172.

In some implementations, the computing device 102 can include a Base Board Management Controller (BMC). In some implementations, the computing device 102 can include a processor, such as a central processing unit (CPU). In some implementations, the computing device 102 can include a controller, such as a Complex Programmable Logic Device (CPLD). In some implementations, the controller can control or monitor the BMC. The controller can provide a Power Good (PG) signal 186 to the power protection circuit 108. The PG signal can be an active high power Power Good indication. The controller can provide an Enable (EN) signal to the power protection circuit 108. When the EN signal is high, the power protection circuit 108 is enabled to provide the output voltage Vout 136 to the peripheral device 104, and the output voltage Vout 136 can be equal to the input voltage VIN 184. When the EN signal is low, the power protection circuit 108 is disabled. The power protection circuit 108 does not provide the power output Vout 136. In some implementations, the computing circuit 172 includes one or more voltage conversion chips, e.g., between the AC power supply and the processor, between the AC power supply and the CPLD, and/or between the AC power supply and the BMC.

The power protection circuit 108 is configured to continue providing or stop providing power to the peripheral device 104 based on the adjustable resistance (provided by the resistance circuit 110) and a sensed current 122 associated with the peripheral device 104. In some implementations, the power protection circuit 108 can be configured to perform a comparison between a first voltage 118 and a second voltage 120. The first voltage 118 can be determined based on the sensed current 122 and a constant resistor 124. The second voltage 120 can be determined based on the adjustable resistance (provided by the resistance circuit 110) and a constant current 126.

The sensed current 122 can be proportional to the current in the peripheral device 104. Thus, the sensed current 122 can be used to determine whether the peripheral device 104 has excessive current. The resistor 124 can be a constant resistor, such as a resistor with 2 ohm. The first voltage 118 can be computed by multiplying the sensed current 122 with the constant resistor 124. Thus, the first voltage 118 is proportional to the current in the peripheral device 104 and can be used to determine whether the peripheral device 104 has excessive current. In some implementations, the computing device 102 can provide power with a constant voltage 136 to the peripheral device 104. Thus, a peripheral device with a greater power requirement can have a higher current, and as a result a higher sensed current 122 and a higher first voltage 118.

The constant current 126 can be determined by an overcurrent limit setting of the power protection circuit 108. The current 126 is a constant value predetermined by the manufacturer of the computing device 102. For example, the current 126 can be 0.1 A. The resistance circuit 110 can provide the adjustable resistance based on the power requirement of the peripheral device 104. The second voltage 120 can be computed by multiplying the adjustable resistance with the constant current 126. Thus, for peripheral devices with different power requirements, the second voltage 120 can be configured to have different values to provide different overcurrent protection settings.

In some implementations, the power protection circuit 108 can be configured to determine whether to stop providing the power, e.g., the voltage output 136, to the peripheral device 104 based on a result of the comparison. For example, when the first voltage 118 is greater than the second voltage 120, the power protection circuit 108 can stop providing the power, e.g., the voltage output 136, to the peripheral device 104. For example, when the first voltage 118 is not greater than the second voltage 120, the power protection circuit 108 can provide or continue to provide the power, e.g., the voltage output 136, to the peripheral device 104.

In some implementations, the power protection circuit 108 can include a comparator 128. In some implementations, the comparator 128 can be an amplifier, e.g., an operational amplifier. The comparator can be configured to compare two input voltages (e.g., the first voltage V+ 118 and the second voltage V− 120) and to output a binary signal indicating which voltage is greater. For example, the comparator 128 can output 0 when the first voltage 118 is not greater than the second voltage 120. The comparator 128 can output a positive power supply voltage when the first voltage 118 is greater than the second voltage 120.

In some implementations, the power protection circuit 108 can include a power switch 130. The power switch 130 can include an input 182, e.g., the system power such as a 12V or 3.3V DC voltage. The power switch 130 can be configured to be controlled by an output 132 of the comparator 128 to generate a voltage output 136. The voltage output 136 can be coupled to the peripheral device 104.

For example, the power switch 130 can be a transistor, such as a Metal-Oxide-Semiconductor Field-Effect Transistor (MOSFET). The power switch 130 can include an input 182 connected to the input power connector pin (VIN) of the power protection circuit 108. The input power connector pin can be connected to the system power of the computing device 102. The system power can have a constant voltage. For example, the computing device 102 can provide a constant voltage at 12V or 3.3V.

The power switch 130 can be controlled by the output 132 of the comparator 128. The output 132 of the comparator 128 can control whether the power switch 130 generates an output voltage 136 that is either equal to the input 182 or zero. If the power switch 130 generates an output voltage 136 that is equal to the input 182, e.g., a constant voltage, the computing device 102 provides power to the peripheral device 104. If the power switch 130 generates an output voltage 136 that is equal to zero, the computing device 102 stops providing power to the peripheral device 104, thus activating overcurrent protection.

In some implementations, the power protection circuit 108 can be configured to determine, using the comparator 128, whether the first voltage 118 is greater than the second voltage 120. In response to determining that the first voltage 118 is greater than the second voltage 120, in some implementations, the power protection circuit 108 can be configured to turn off the power switch 130, causing to stop providing the power, e.g., the voltage output 136, to the peripheral device 104. In response to determining that the first voltage 118 is no greater than the second voltage 120, the power protection circuit 108 can be configured to turn on the power switch 130, causing to provide the power, e.g., the voltage output 136, to the peripheral device 104.

In some implementations, the power protection circuit 108 can further include a control transistor 138. For example, the transistor 138 can be a MOSFET. The control transistor 138 can have a first terminal coupled to the input 140 of the power switch 130. The control transistor 138 can have a second terminal coupled to a ground reference voltage 142, and a gate terminal coupled to the output 132 of the comparator 128.

In some implementations, the control transistor 138 can be configured to be turned on in response to the first voltage 118 being greater than the second voltage 120, causing to turn off the power switch 130. For example, when the first voltage 118 is greater than the second voltage 120, the output 132 of the comparator 128 can be a signal (e.g., a positive power supply voltage) that turns on the control transistor 138. Because the control transistor 138 is turned on, the input 140 to the power switch 130 is connected to the ground reference voltage 142. Because the input 140 to the power switch 130 is connected to the ground reference voltage 142, the power switch 130 is turned off. Thus, the voltage output 136 from the power switch 130 is turn off, causing that the input voltage VIN 184 cannot pass through to the voltage output 136. The power protection circuit 108 stops providing power, e.g., a voltage at 12V or 3.3V, to the peripheral device 104. Thus, the overcurrent protection is activated.

In some implementations, the control transistor 138 can be configured to be turned off in response to the first voltage 118 not being greater than (or smaller than) the second voltage 120, causing to turn on the power switch 130. For example, when the first voltage 118 is not greater than the second voltage 120, the output 132 of the comparator 128 can be a signal (e.g., 0) that turns off the control transistor 138. Because the control transistor 138 is turned off, the input 140 to the power switch 130 is not connected to the ground reference voltage 142. Because the input 140 to the power switch 130 is not connected to the ground reference voltage 142, the power switch 130 is turned on. Thus, the voltage output 136 from the power switch 130 is equal to the input 182. The power protection circuit 108 provides power, e.g., a voltage at 12V or 3.3V, to the peripheral device 104. Thus, the overcurrent protection is not activated.

In some implementations, the power protection circuit 108 can include a control logic circuit 144. The control logic circuit 144 can be configured to generate the sensed current 122 based on at least one of a current in the peripheral device 104, a type of the peripheral device 104, or the power requirement of the peripheral device 104. For example, the power protection circuit 108 can obtain a current 134 that is approximately equal to the current in the peripheral device 104. For example, the Isense current 134 can be approximately the same as the current in the peripheral device 104 while the power protection circuit 108 is monitoring the peripheral device 104. The current 134 can be an input to the control logic circuit 144. The control logic circuit 144 can generate the sensed current 122 using the current 134. In some implementations, the sensed current 122 generated by the control logic circuit 144 can be proportional to the current 134. In some implementations, the sensed current 122 can be equal to the current 134 divided by a constant number. The constant number can be a predetermined number by the manufacturer of the computing device 102. For example, the constant number can be 10. For example, if the current 134 is 100 A, the sensed current 122 is 100 A/10=10 A.

In some implementations, the resistance circuit 110 can include a plurality of resistors 148. Each of the plurality of resistors 148 can be coupled between an input 146 of the power protection circuit 108 and a ground reference voltage 150. For example, the resistance circuit 110 includes five resistors: R1, R2, R3, R4, and R5. The power protection circuit 108 can have an input 146 that provides the constant current 126. Each resistor is coupled between the input 146 and the ground reference voltage 150. The constant current 126 always flows through R1, and optionally may or may not flow through one or more of the other resistors R2, R3, R4, and R5 (e.g., by turning on or turning off respective transistors 152, as discussed herein), thus providing the adaptive resistance or adjustable resistance. The system 100 can use the adaptive (or adjustable) resistance to provide different overcurrent protection settings to protect peripheral devices with different power requirements.

In some implementations, the resistance circuit 110 can include one or more transistors 152. In some implementations, some, or all of the one or more transistors 152 can be a MOSFET. Each transistor of the one or more transistors 152 can be coupled in series with a respective resistor of the plurality of resistors 148 between the input 146 of the power protection circuit 108 and the ground reference voltage 150. Each transistor 152 can be configured to be turned on or turned off based on at least a corresponding sense signal of the one or more sense signals 112, 114, and 116, from the one or more connectors 106.

For example, the resistance circuit 110 can include four transistors MOS1, MOS2, MOS3, and MOS4. Here, MOS is short for a MOSFET transistor. The transistor MOS1 is coupled in series with the resistor R2 between the input 146 of the power protection circuit 108 and the ground reference voltage 150. The transistor MOS1 is configured to be turned on or off based on the sense signal 116 from the PCIe 2×4 connector 106b.

In some examples, when the PCIe 2×4 connector 106b connects to the 2×4 auxiliary power connector 170 of the PCIe device 104, the sense signal 116 has a lower voltage level. When the sense signal 116 has a lower voltage level, the transistor MOS1 is turned off, causing the constant current 126 not passing through R2. Thus, R2 does not contribute to the overall resistance of the resistance circuit 110. In some examples, when the PCIe 2×4 connector 106b does not connect to the 2×4 auxiliary power connector 170 of the PCIe device 104, the sense signal 116 has a higher voltage level. When the sense signal 116 has a higher voltage level, the transistor MOS1 is turned on, causing the constant current 126 passing through R2. Thus, R1 and R2 in parallel both contribute to the overall resistance of the resistance circuit 110.

In some examples, the transistor MOS2 is coupled in series with the resistor R3 between the input 146 of the power protection circuit 108 and the ground reference voltage 150. The transistor MOS2 is configured to be turned on or off based on the sense signal 114 from the PCIe 2×4 connector 106b. When the PCIe 2×4 connector 106b connects to the 2×4 auxiliary power connector 170 of the PCIe device 104, the transistor MOS2 is turned off, causing the constant current 126 not passing through R3. Thus, R3 does not contribute to the overall resistance of the resistance circuit 110. When the PCIe 2×4 connector 106b does not connect to the 2×4 auxiliary power connector 170 of the PCIe device 104, the transistor MOS2 is turned on, causing the constant current 126 passing through R3. Thus, R3 contributes to the overall resistance of the resistance circuit 110.

In some examples, the transistor MOS3 is coupled in series with the resistor R4 between the input 146 of the power protection circuit 108 and the ground reference voltage 150. The transistor MOS3 is configured to be turned on or off based on the sense signal 112 from the PCIe 2×3 connector 106a. When the PCIe 2×3 connector 106a connects to the 2×3 auxiliary power connector 168 of the PCIe device 104, the transistor MOS3 is turned off, causing the constant current 126 not passing through R4. Thus, R4 does not contribute to the overall resistance of the resistance circuit 110. When the PCIe 2×3 connector 106a does not connect to the 2×3 auxiliary power connector 168 of the PCIe device 104, the transistor MOS3 is turned on, causing the constant current 126 passing through R4. Thus, R4 contributes to the overall resistance of the resistance circuit 110.

In some implementations, a number of the plurality of resistors 148 can be greater than a number of the one or more transistors 152. For example, the resistance circuit 110 can include five resistors 148 and four transistors 152. The resistor R1 is not coupled with a transistor. Each of the other resistors is coupled with a corresponding transistor.

In some implementations, the one or more connectors 106 can include a first connector 106a having at least one first node 154 configured to provide at least one first sense signal 112. For example, the PCIe 2×3 connector 106a can have a node 154 configured to provide the sense signal 112. In some implementations, the one or more connectors 106 can include a second connector 106b having one or more second nodes 156 and 158 configured to provide one or more second sense signals 114 and 116. For example, the PCIe 2×4 connector 106b can have one second node 156 configured to provide the sense signal 114 and another one second node 158 configured to provide the sense signal 116.

In some implementations, each node of the at least one first node 154 and the at least one second node 156 and 158 can be coupled to a corresponding transistor of the one or more transistors 152. For example, the node 154 can be coupled to the transistor MOS3. The node 156 can be coupled to the transistor MOS2. The node 158 can be coupled to the transistor MOS1.

In some implementations, each node of the at least one first node 154 and the at least one second node 156 and 158 can be configured to provide a respective sense signal 112, 114, and 116 to the corresponding transistor 152. For example, the node 154 can be configured to provide the sense signal 112 to the transistor MOS3. The node 156 can be configured to provide the sense signal 114 to the transistor MOS2. The node 158 can be configured to provide the sense signal 116 to the transistor MOS1.

In some implementations, the adjustable resistance of the resistance circuit 110 can be adjusted according to a combination of the one or more sense signals 112, 114, and 116. In some implementations, the computing device 102 can further include a logic gate 160. The logic gate 160 can have inputs coupled to at least two nodes of the at least one first node 154 and the at least one second node 156 and 158. The logic gate 160 can have an output 162 coupled to a particular transistor of the one or more transistors 152.

For example, the computing device 102 can include a logic gate 160. The logic gate 160 can be AND gate, OR gate, NOT gate, NAND gate, NOR gate, XNOR gate, another type of logic gate, or a combination of these. In the example system 100 in FIG. 1, the computing device 102 includes a logic gate 160 that is an AND gate. The logic gate 160 has three inputs coupled to the node 154 of the connector 106a and the nodes 156 and 158 of the connector 106b. The logic gate 160 has an output AND_Out 162. The output 162 is coupled to the transistor MOS4. Because the logic gate is an AND gate, the output 162 is a high signal only if all the inputs are high.

For example, the transistor MOS4 is coupled in series with the resistor R5 between the input 146 of the power protection circuit 108 and the ground reference voltage 150. The transistor MOS4 is configured to be turned on or off based on the output 162 from the logic gate 160. When the PCIe 2×3 connector 106a connects to the 2×3 auxiliary power connector 168 of the PCIe device 104 or when the PCIe 2×4 connector 106b connects to the 2×4 auxiliary power connector 170 of the PCIe device 104, at least one of the inputs to the logic gate 160 is low, e.g., at a lower voltage level. Thus, the output 162 from the logic gate 160 is at a lower voltage level. Because the output 162 is at a lower voltage level, the transistor MOS4 is turned off, causing the constant current 126 not passing through R5. Thus, R5 does not contribute to the overall resistance of the resistance circuit 110.

When the PCIe 2×3 connector 106a does not connect to the 2×3 auxiliary power connector 168 of the PCIe device 104 and the PCIe 2×4 connector 106b does not connect to the 2×4 auxiliary power connector 170 of the PCIe device 104, each of the inputs to the logic gate 160 is high, e.g., at a higher voltage level. Thus, the output 162 from the logic gate 160 is at a higher voltage level. Because the output 162 is at a higher voltage level, the transistor MOS4 is turned on, causing the constant current 126 passing through R5. Thus, R5 contributes to the overall resistance of the resistance circuit 110.

In some implementations, the computing device 102 can further include a control logic 164. The control logic 164 can be coupled between the one or more connectors 106 and the resistance circuit 110. The control logic 164 can be configured to provide the one or more sense signals 112, 114, and 116, respectively to the one or more transistors 152. In some implementations, the control logic 164 can include the logic gate 160 discussed above.

For example, the control logic 164 can be a CPLD. The control logic 164 can be coupled between the connectors 106a and 106b, and the resistance circuit 110. The control logic 164 can be configured to receive inputs from the nodes 154, 156, and 158 of the connectors 106a and 106b. The control logic 164 can be configured to provide the one or more sense signals 112, 114, and 116, respectively to the transistors MOS3, MOS2, and MOS1. The control logic 164 can include the logic gate 160. The logic gate 160 in the control logic 164 can be configured to provide the AND_out output 162 to the transistor MOS4.

FIGS. 2A-2D illustrate examples of the computing device 102 in FIG. 1 configured to provide overcurrent protection for peripheral devices with different power requirements. In these examples, the sensed current 122 associated with the peripheral device, e.g., Icsref 122, can be a fraction of the current Isense 134 from the input voltage VIN 184. The fraction can be predetermined by the manufacturer of the computing device 102. For example, Icsref can be equal to Isense divided by 10. The constant current Iocref 126 can have a predetermined value, such as 0.1 A.

The system 100 can be configured to have a constant factor for overcurrent protection. In the examples in FIGS. 2A-2D, the constant factor can be 1.5. The overcurrent protection setting (e.g., maximum value allowed for the current Isense 134) for a 300 W PCIe device can be: 1.5×(300 W/12V)=37.5 A. The overcurrent protection setting for a 225 W PCIe device can be: 1.5×(225 W/12V)=28.125 A. The overcurrent protection setting for a 150 W PCIe device can be: 1.5×(150 W/12V)=18.75 A. The overcurrent protection setting for a 75 W PCIe device can be: 1.5×(75 W/12V)=9.375 A.

In the examples in FIGS. 2A-2D, the resistors 148 can be designed to have resistance values such that the adaptable (or adjustable) resistance of the resistance circuit 110 can provide the above desired overcurrent protection settings. For example, R1 is 75 ohm, R2 is 150 ohm, R3 is 150 ohm, R4 is 225 ohm, and R5 is 45 ohm. For example, the constant resistor 124 is 2 ohm.

FIG. 2A illustrates an example of the computing device 102 in FIG. 1 configured to provide overcurrent protection for a peripheral device 202 with a 300 W power requirement. In some implementations, the peripheral device 202 can be connected with each of the one or more connectors 106. For example, the peripheral device 202 can be a PCIe device with a 300 W power requirement. To supply the required 300 W power, the peripheral device 202 can connect its 2×3 auxiliary power connector 168 to the PCIe 2×3 connector 106a using a PCIe 2×3 power cable to get 75 W of power, can connect its 2×4 auxiliary power connector 170 to the PCIe 2×4 connector 106b using a PCIe 2×4 power cable to get 150 W of power, and can connect its PCIe ×16 gold finger to the PCIe ×16 connector 106c to get 75 W of power.

Connecting with each of the one or more connectors 106 can cause each of the one or more sense signals 112, 114, and 116, to have the predetermined voltage level, e.g., the lower voltage level. For example, each of the sense signals 112, 114, and 116 can be at the lower voltage level. In some implementations, each of the sense signals 112, 114, and 116 can be a ground reference voltage because the sense pins in the power connectors 168 and 170 are connected to the ground reference voltage.

The one or more sense signals having the predetermined voltage level, e.g., the lower voltage level, can turn off the one or more transistors 152 in the resistance circuit 110. Because the one or more transistors 152 are turned off, the adjustable resistance is based on at least one remaining resistor (e.g., R1) in the resistance circuit. The at least one remaining resistor (e.g., R1) can be independent from one or more resistors (e.g., R2, R3, R4, and R5) coupled in series with the one or more transistors 152.

For example, as illustrated in FIG. 2A, because each of the sense signals 112, 114, and 116 are at the lower voltage level, the transistors MOS1, MOS2, and MOS3 are turned off. Further, the output 162 from the logic gate 160 is at the lower voltage level, causing the transistor MOS4 to be turned off as well. Because all the transistors are turned off, the constant current does not pass through the resistors R2, R3, R4, and R5 that are respectively coupled with the transistors MOS1, MOS2, MOS3, and MOS4. The only remaining active resistor is R1. The remaining resistor R1 is independent from the resistors R2, R3, R4, and R5 coupled in series with the one or more transistors MOS1, MOS2, MOS3, and MOS4. Thus, the resistance of the resistance circuit 110 is R1.

Because the resistance of the resistance circuit 110 is R1, the second voltage (V−) 120 is the product of the constant current 126 and the resistance R1. Thus, V−=Iocref×R1=0.1×75=7.5V. The first voltage (V+) 118 is the product of the constant resistor RCS 124 and the sensed current 122. Thus, when Isense 134 is equal to the maximum value allowed (e.g., 37.5 A), V+=Icsref×Res=(Isense/10)×2=3.75×2=7.5V.

The current Isense 134 represents the variable output current generated from the peripheral device 202. When Isense 134 is no greater than 37.5 A, V+ is no greater than V−. Thus, the output 132 from the comparator 128 is 0, and the overcurrent protection is not activated. When Isense 134 is greater than 37.5 A, V+ is greater than V−. Thus, the output 132 from the comparator 128 is Voltage at the Drain (VDD), e.g., a positive power supply. The positive output 132 can turn on the control transistor 138, which in response, turns off the power switch 130. Therefore, the overcurrent protection is activated, and the power protection circuit 108 stops providing output voltage Vout 136 to the peripheral device 202.

FIG. 2B illustrates an example of the computing device 102 in FIG. 1 configured to provide overcurrent protection for a peripheral device 204 with a 225 W power requirement. FIG. 2C illustrates an example of the computing device 102 in FIG. 1 configured to provide overcurrent protection for a peripheral device 206 with a 150 W power requirement. In some implementations, the peripheral device can be disconnected from at least one of the one or more connectors. For example, in FIG. 2B, the peripheral device 204 is disconnected from the PCIe 2×3 connector 106a. For example, in FIG. 2C, the peripheral device 206 is disconnected from the PCIe 2×4 connector 106b.

Disconnecting from at least one of the one or more connectors can cause at least one sense signal of the one or more sense signals 112, 114, and 116, to not have the predetermined voltage level, e.g., at least one sense signal of the one or more sense signals can have a higher voltage level. For example, as illustrated in FIG. 2B, the sense signal 112 can have a higher voltage level. For example, as illustrated in FIG. 2C, the sense signals 114 and 116 can have a higher voltage level.

The at least one sense signal not having the predetermined voltage level (or having the higher voltage level) can turn on at least one corresponding transistor 152 in the resistance circuit 110. Because the at least one corresponding transistor 152 in the resistance circuit 110 is turned on, the adjustable resistance for the peripheral device 204 can be based on at least one resistor 148 coupled in series with the at least one corresponding transistor 152.

For example, as illustrated in FIG. 2B, for the 225 W peripheral device 204 in FIG. 2B, because the sense signal 112 has a high voltage level, the corresponding transistor MOS3 controlled by the sense signal 112 is turned on. Because the resistor R4 couples in series with the transistor MOS3, the resistor R4 is active. Because the sense signals 114 and 116 are at the lower voltage level, the transistors MOS1, MOS2, and MOS4 for R2, R3, and R5 are turned off. The active resistors are R1 and R4 in parallel. The adjustable resistance for the peripheral device 204 is the resistance of the resistor R4 and the resistor R1 in parallel, e.g., (R1∥R4).

The first voltage (V+) is the product of the constant resistor RCS 124 and the sensed current 122. Thus, when Isense 134 is equal to the maximum value allowed (e.g., 28.125 A), V+=Icsref×Res=(Isense/10)×2=2.8125×2=5.625V. The second voltage (V−) is the product of the constant current 126 and the resistance (R1∥R4). Thus,

$$V -= Iocref \times ( \frac{R 1 \times R 4}{R 1 + R 4} ) = 0.1 \times ( \frac{75 \times 225}{75 + 225} ) = 0.1 \times 56. 25 = 5.625 V .$$

The current Isense 134 represents the variable output current generated from the peripheral device 204. When Isense 134 is no greater than 28.125 A, V+ is no greater than V−. Thus, the output 132 from the comparator 128 is 0, and the overcurrent protection is not activated. When Isense 134 is greater than 28.125 A, V+ is greater than V−. Thus, the output 132 from the comparator 128 is VDD, e.g., a positive power supply. The positive output 132 can turn on the control transistor 138, which in response, turns off the power switch 130. Therefore, the overcurrent protection is activated, and the power protection circuit 108 stops providing output voltage Vout 136 to the peripheral device 204.

For example, as illustrated in FIG. 2C, for the 150 W peripheral device 206 in FIG. 2C, because the sense signals 114 and 116 have a high voltage level, the corresponding transistors MOS 1 and MOS2 controlled by the sense signals 114 and 116 are turned on. The resistor R2 couples in series with the transistor MOS1. The resistor R3 couples in series with the transistor MOS2. Thus, the resistors R1 and R2 are active. Because the sense signal 112 is at the lower voltage level, the transistor MOS3 and MOS4 for R4 and R5 are turned off. The active resistors are R1, R2, and R3 in parallel. The adjustable resistance for the peripheral device 206 is the resistance of the resistors R1, R2, and R3 in parallel, e.g., (R1∥R2∥R3).

The first voltage (V+) is the product of the constant resistor RCS 124 and the sensed current 122. Thus, when Isense 134 is equal to the maximum value allowed (e.g., 18.75 A), V+=Icsref×Res=(Isense/10)×2=1.875×2=3.75V. The second voltage (V−) is the product of the constant current 126 and the resistance (R1∥R2∥R3). Thus,

$$V -= Iocref \times ( \frac{R 1 \times \frac{R 2 \times R 3}{R 2 + R 3}}{( R 1 + ( \frac{R 2 \times R 3}{R 2 + R 3} ) )} ) = 0.1 \times ( \frac{75 \times \frac{150 \times 150}{150 + 150}}{( 75 + ( \frac{150 \times 150}{150 + 150} ) )} ) = 0.1 \times 37. 5 = 3.75 V .$$

The current Isense 134 represents the variable output current generated from the peripheral device 206. When Isense 134 is no greater than 18.75 A, V+ is no greater than V−. Thus, the output 132 from the comparator 128 is 0, and the overcurrent protection is not activated. When Isense 134 is greater than 18.75 A, V+ is greater than V−. Thus, the output 132 from the comparator 128 is VDD, e.g., a positive power supply. The positive output 132 can turn on the control transistor 138, which in response, turns off the power switch 130. Therefore, the overcurrent protection is activated, and the power protection circuit 108 stops providing output voltage Vout 136 to the peripheral device 206.

FIG. 2D illustrates an example of the computing device 102 in FIG. 1 configured to provide overcurrent protection for a peripheral device 208 with a 75 W power requirement. In some implementations, the peripheral device 208 can be disconnected from each of the one or more connectors 106a and 106b. This can cause the one or more sense signals 112, 114, and 116 to not have the predetermined voltage level. For example, the one or more sense signals 112, 114, and 116 can have a higher voltage level. The one or more sense signals 112, 114, and 116 not having the predetermined voltage level can turn on the one or more transistors 152 in the resistance circuit 110. Because the one or more transistors 152 in the resistance circuit 110 are turned on, the adjustable resistance for the peripheral device 208 is based on at least one or more resistors 148 coupled in series with the one or more transistors 152.

For example, as illustrated in FIG. 2D, each of the transistors MOS1, MOS2, MOS3, and MOS4 is turned on because each of the sense signals 112, 114, and 116 has a higher voltage level. The resistors R2, R3, R4, and R5 coupled in series with the transistors MOS1, MOS2, MOS3, and MOS4 are active. The adjustable resistance for the peripheral device 208 is the resistance of R1, R2, R3, R4, and R5 in parallel, e.g., (R1∥R2∥R3∥R4∥R5).

The first voltage (V+) is the product of the constant resistor RCS 124 and the sensed current 122. Thus, when Isense 134 is equal to the maximum value allowed (e.g., 9.375 A), V+=Icsref×Res=(Isense/10)×2=0.9375×2=1.875V. The second voltage (V−) is the product of the constant current 126 and the resistance (R1∥R2∥R3∥R4∥R5). Thus,

$$V -= Iocref \times \frac{\frac{R 4 \times R 5}{R 4 + R 5} \times RLIM\_ ( 150 W )}{( \frac{R 4 \times R 5}{R 4 + R 5} + RLIM\_ ( 150 W ) )} = 0.1 \times ( \frac{3 7.5 \times 37. 5}{( 37.5 + 37.5 )} ) = 0.1 \times 18. 75 = 1.8 \; 75 V .$$

Here, RLIM_(150 W) is the adaptive resistance of the resistance circuit 110 for the 150 W device in FIG. 2C.

The current Isense 134 represents the variable output current generated from the peripheral device 206. When Isense 134 is no greater than 9.375 A, V+ is no greater than V−. Thus, the output 132 from the comparator 128 is 0, and the overcurrent protection is not activated. When Isense 134 is greater than 9.375 A, V+ is greater than V−. Thus, the output 132 from the comparator 128 is VDD, e.g., a positive power supply. The positive output 132 can turn on the control transistor 138, which in response, turns off the power switch 130. Therefore, the overcurrent protection is activated, and the power protection circuit 108 stops providing output voltage Vout 136 to the peripheral device 208.

Table 3 shows an example of adjustable resistance provided by the resistance circuit.

TABLE 3
Adjustable resistance

| AND_Out | Sense2 | Sense1 | Sense0 | | |
|---|---|---|---|---|---|
| (R5) | (R4) | (R3) | (R2) | Power(W) | Adjustable Resistance |
| 0 | 0 | 0 | 0 | 300 | RILIM_(300 W) = R1 |
| 0 | 1 | 0 | 0 | 225 | $RILIM\_ ( 225 W ) = \frac{R 1 \times R 4}{R 1 + R 4}$ |
| 0 | 0 | 1 | 1 | 150 | $RILIM\_ ( 150 W ) = \frac{R 1 \times \frac{R 2 \times R 3}{R 2 + R 3}}{( R 1 + ( \frac{R 2 \times R 3}{R 2 + R 3} ) )}$ |
| 1 | 1 | 1 | 1 | 75 | $RILIM\_ ( 75 W ) = \frac{( R 4 \vert \vert R 5 ) \times RILIM\_ ( 150 W )}{( R 4 \vert \vert R 5 ) + RILIM\_ ( 150 W )}$ |

Referring back to FIG. 1, in some implementations, the peripheral device 104 can further include power pins coupled to at least one of the first connector or the second connector. FIG. 3A illustrates an example of a computing system 300a including a computing device 320 configured to provide overcurrent protection for an OCP device 310 with an 80 W power requirement. The computing device 320 shares some same or similar components (e.g., the power protection circuit 108 and the resistance circuit 110) as the computing device 102, and these components are referred to using the reference numbers in FIG. 1. Here, the peripheral device is the OCP device 310. The computing device 320 can include a first connector 302 and a second connector 304. The first connector 302 can be a primary connector “4C+” that provides power to a peripheral device. The second connector 304 can be a secondary connector “4C” that provides additional power to the peripheral device. The OCP device 310 can include power pins 306, e.g., OCP 4C+ gold finger. The power requirement of the OCP device 310 is 80 W. Thus, the power pins 306 is coupled to the first connector 302 included in the computing device 320, to provide power to the OCP device 310. The OCP device 310 does not need to be connected to the secondary connector 304.

FIG. 3B is an example of a computing system 300b including a computing device 320 configured to provide overcurrent protection for an OCP device 312 with an 150 W power requirement. The computing device 320 shares some same or similar components (e.g., the power protection circuit 108 and the resistance circuit 110) as the computing device 102, and these components are referred to using the reference number in FIG. 1. Here, the peripheral device is the OCP device 312. The OCP device 312 can include first power pins 306, e.g., OCP 4C+ gold finger, and second power pins 308, e.g., OCP 4C gold finger. The power requirement of the OCP device 312 is 150 W. Thus, the power pins 306 are coupled to the first connector 302 included in the computing device 320, and the power pins 308 are coupled to the second connector 304, to provide power to the OCP device 312.

The power protection circuit in the computing device 320 is configured to provide overcurrent protection to an OCP device with different power requirements. The resistance circuit 110 is connected to the power protection circuit. The resistance circuit in the computing device 320 is configured to provide to the power protection circuit an adjustable resistance based on the three sense signals 112, 114, and 116. In FIGS. 3A-3B, the sense signals 112 and 114 always have a higher voltage level. The sense signal 116 can have a variable voltage level based on whether the OCP device is connected to the secondary connector 304.

In FIG. 3A, the secondary connector 304 is not connected to the OCP device 310 with the 80 W power requirement. The sense signal 116 can have a higher voltage level. Thus, the resistor MOS1 coupled with the resistor R2 is turned on. Both R1 and R2 are active. Thus, the adjustable resistance provided by the resistance circuit is based on R1, R2, R3, R4, and R5 in parallel.

In FIG. 3B, the secondary connector 304 is connected to the OCP device 312 with the 150 W power requirement. The sense signal 116 can have a lower voltage level. Thus, the resistor MOS1 coupled with the resistor R2 is turned off, and R2 is not active. Thus, the adjustable resistance provided by the resistance circuit is based on R1, R3, R4, and R5 in parallel. This resistance in FIG. 3B can be greater than the resistance in FIG. 3A. Therefore, the resistance in FIG. 3B can satisfy the higher overcurrent setting needed by the OCP device 312 that has a higher power requirement than the OCP device 310 in FIG. 3A.

In some implementations, the resistance circuit for an OCP device can have a different design. For example, the resistance circuit may not include the resistors R3, R4, and R5 and the transistors coupled with them. In some implementations, the computing device 320 may not need to provide the sense signals 112 and 114 to the resistance circuit.

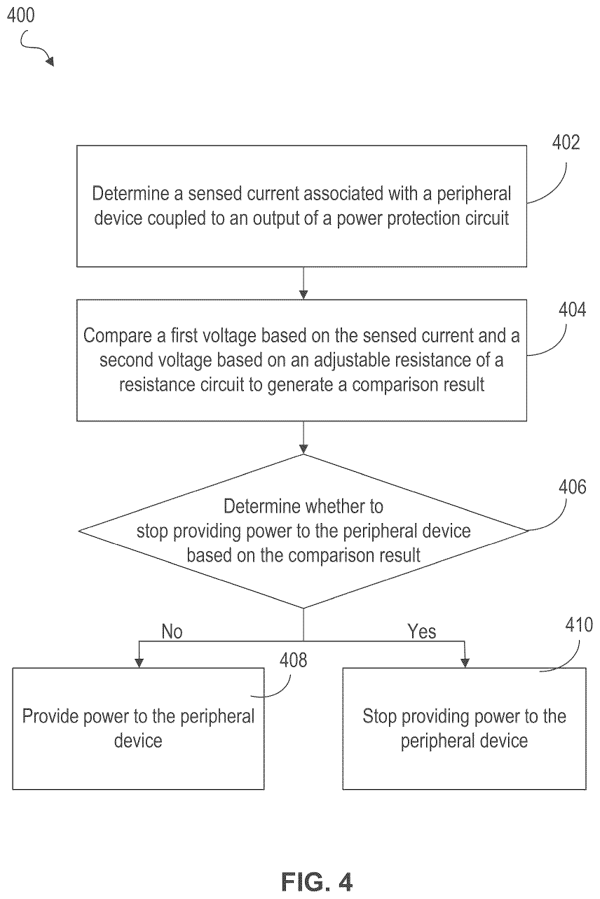

FIG. 4 is a flowchart of an example process 400 of a method for managing overcurrent protection for a peripheral device. For clarity of presentation, the description that follows generally describes the method in the context of the other figures in this description. However, it will be understood that the process 400 can be performed, for example, by any system, environment, software, and hardware, or a combination of systems, environments, software, and hardware, as appropriate. In some implementations, various steps of the process 400 can be run in parallel, in combination, in loops, or in any order. In some implementations, a computing device can perform one or more, or all of the steps described in the process 400. The computing device can be the same as, or similar to, the computing device 102 of FIG. 1, FIG. 2A, 2B, 2C, or 2D, or the computing device 320 of FIG. 3A or 3B. The peripheral device can be the same as, or similar to, the peripheral device 104 of FIG. 1.

At 402, the computing device can determine a sensed current (e.g., the sensed current 122 of FIG. 1) associated with a peripheral device coupled to an output of a power protection circuit (e.g., the power protection circuit 108 of FIG. 1). The power protection circuit can be configured to provide overcurrent protection to the peripheral device that is connected to the computing device. In some implementations, the power protection circuit can include a control logic circuit (e.g., the control logic circuit 144 of FIG. 1) configured to generate the sensed current based on at least one of a current in the peripheral device, a type of the peripheral device, or the power requirement of the peripheral device.

In some implementations, the computing device can include one or more connectors (e.g., the connectors 106a and 106b of FIG. 1, or the connectors 304 and 302 of FIGS. 3A-3B) configurable to connect one or more peripheral devices that have one or more corresponding power requirements. In some implementations, the peripheral device can include power pins (e.g., the gold finger 174 of FIG. 1) coupled to the output (e.g., Vout 136 of FIG. 1) of the power protection circuit. In some implementations, the peripheral device can include a first power connector (e.g., the power connector 168 of FIG. 1) configurable to connect to the first connector (e.g., the connector 106a of FIG. 1) of the one or more connectors. In some implementations, the peripheral device can include a second power connector (e.g., the power connector 170 of FIG. 1) configurable to connect to the second connector (e.g., the connector 106b of FIG. 1) of the one or more connectors. In some implementations, the peripheral device can include power pins (e.g., the gold finger power pins 308 and 306 of FIGS. 3A-3B) coupled to at least one of the first connector (e.g., the connector 304 of FIGS. 3A-3B) or the second connector (e.g., the connector 302 of FIGS. 3A-3B).

At 404, the computing device can compare a first voltage (e.g., V+ 118 of FIG. 1) based on the sensed current (e.g., the sensed current 122 of FIG. 1) and a second voltage (e.g., V− 120 of FIG. 1) based on an adjustable resistance of a resistance circuit (e.g., the resistance circuit 110 of FIG. 1) to generate a comparison result. In some implementations, the first voltage can be determined based on the sensed current and a constant resistor (e.g., the RCS 124 of FIG. 1). In some implementations, the second voltage can be determined based on the adjustable resistance and a constant current (e.g., the current locref 126 of FIG. 1).

In some implementations, the resistance circuit can be coupled to an input (e.g., the input 146 of FIG. 1) of the power protection circuit. The power protection circuit can be configured to stop providing power to the peripheral device based on the adjustable resistance and the sensed current associated with the peripheral device.

The adjustable resistance can be based on one or more sense signals (e.g., the sensed signals 112, 114, and 116 of FIG. 1) from the one or more connectors coupled to the output of the power protection circuit. The one or more connectors can be configurable to be connected to the peripheral device according to a power requirement of the peripheral device. The one or more sense signals can be based on a connection status between the one or more connectors and the peripheral device. The one or more sense signals can indicate the power requirement of the peripheral device.

In some implementations, the resistance circuit can include a plurality of resistors (e.g., the resistors 148 of FIG. 1). In some implementations, each resistor of the plurality of resistors can be coupled between an input (e.g., the input 146 of FIG. 1) of the power protection circuit and a ground reference voltage (e.g., the ground reference voltage 150 of FIG. 1). An output of the power protection circuit can be coupled to the peripheral device and the one or more connectors. In some implementations, the resistance circuit can include one or more transistors (e.g., the transistors 152 of FIG. 1). In some implementations, each transistor of the one or more transistors can be coupled in series with a respective resistor of the plurality of resistors between the input of the power protection circuit and the ground reference voltage. In some implementations, each transistor of the one or more transistors can be configured to be turned on or off based on at least a corresponding sense signal of the one or more sense signals from the one or more connectors.

In some implementations, the one or more connectors can include a first connector (e.g., the connector 106a of FIG. 1) having at least one first node (e.g., the node 154 of FIG. 1) configured to provide at least one first sense signal (e.g., the sense signal 112 of FIG. 1), and a second connector (e.g., the connector 106b of FIG. 1) having at least one second node (e.g., the node 156 and the node 158 of FIG. 1) configured to provide at least one second sense signal (e.g., the sense signals 114 and 116 of FIG. 1). In some implementations, each node of the at least one first node and the at least one second node can be coupled to a corresponding transistor of the one or more transistors and can be configured to provide a respective sense signal to the corresponding transistor.

In some implementations, the computing device can include a logic gate (e.g., the logic gate 160 of FIG. 1) having inputs coupled to at least two nodes of the at least one first node and the at least one second node and an output coupled to a particular transistor (e.g., the transistor MOS4 of FIG. 1) of the one or more transistors. In some implementations, the computing device can include a control logic (e.g., the control logic 164 of FIG. 1) coupled between the one or more connectors and the resistance circuit and configured to provide the one or more sense signals respectively to the one or more transistors.

In some implementations, the peripheral device can be connected with each of the one or more connectors. The peripheral device being connected with each of the one or more connectors can cause each of the one or more sense signals to have a lower voltage level to turn off the one or more transistors in the resistance circuit. By turning off the one or more transistors in the resistance circuit, the adjustable resistance for the peripheral device can be based on at least one remaining resistor in the resistance circuit, independent from one or more resistors coupled in series with the one or more transistors. For example, as described above in reference to FIG. 2A, the adjustable resistance for the 300 W peripheral device 202 can be based on the remaining resistor R1 in the resistance circuit.

In some implementations, the peripheral device can be disconnected from at least one of the one or more connectors. The peripheral device being disconnected from at least one of the one or more connectors can cause at least one sense signal of the one or more sense signals to have a higher voltage level to turn on at least one corresponding transistor in the resistance circuit. By turning on at least one corresponding transistor in the resistance circuit, the adjustable resistance for the peripheral device can be based on at least one resistor coupled in series with the at least one corresponding transistor.

For example, as described above in reference to FIG. 2B, the adjustable resistance for the 225 W peripheral device 204 can be based on the resistor R4 that is coupled with the transistor MOS3 in the resistance circuit, and the resistor R1, in parallel. For example, as described above in reference to FIG. 2C, the adjustable resistance for the 150 W peripheral device 206 can be based on the resistors R3 and R2 that are coupled with the transistors MOS2 and MOS1 in the resistance circuit, and the resistor R1, in parallel.

In some implementations, the peripheral device can be disconnected from each of the one or more connectors. The peripheral device being disconnected from each of the one or more connectors can cause the one or more sense signals to have a higher voltage level to turn on the one or more transistors. By turning on the one or more transistors, the adjustable resistance for the peripheral device can be based on at least one or more resistors coupled in series with the one or more transistors. For example, as described above in reference to FIG. 2C, the adjustable resistance for the 75 W peripheral device 208 can be based on all of the resistors R1, R2, R3, R4, and R5 in parallel.

At 406, the computing device can determine whether to stop providing power to the peripheral device based on the comparison result. In some implementations, the power protection circuit can include a comparator (e.g., the comparator 128 of FIG. 1) and a power switch (e.g., the power switch 130 of FIG. 1). In some implementations, the power switch can have an input (e.g., the input 140 of FIG. 1) configured to be controlled by an output (e.g., the output 132 of FIG. 1) of the comparator and an output (e.g., the Vout 136 of FIG. 1) coupled to the peripheral device. In some implementations, the power protection circuit can be configured to determine, using the comparator, whether the first voltage is greater than the second voltage.

At 408, in response to determining to not stop providing power to the peripheral device based on the comparison result, the computing device can provide power to the peripheral device. In some implementations, in response to determining that the first voltage is no greater than the second voltage, the power protection circuit can be configured to turn on the power switch, causing to provide the power to the peripheral device.

In some implementations, the power protection circuit can further include a control transistor (e.g., the transistor MOS_OC 138 of FIG. 1) having a first terminal coupled to the input of the power switch, a second terminal coupled to a ground reference voltage, and a gate terminal coupled to the output of the comparator. In some implementations, the control transistor can be configured to be turned off in response to the first voltage being no greater than the second voltage, causing to turn on the power switch, as described above in reference to FIG. 1.

At 410, in response to determining to stop providing power to the peripheral device based on the comparison result, the computing device can stop providing power to the peripheral device. In some implementations, in response to determining that the first voltage is greater than the second voltage, the power protection circuit can be configured to turn off the power switch, causing to stop providing the power to the peripheral device. In some implementations, the control transistor can be configured to be turned on in response to the first voltage being greater than the second voltage, causing to turn off the power switch, as described above in reference to FIG. 1.

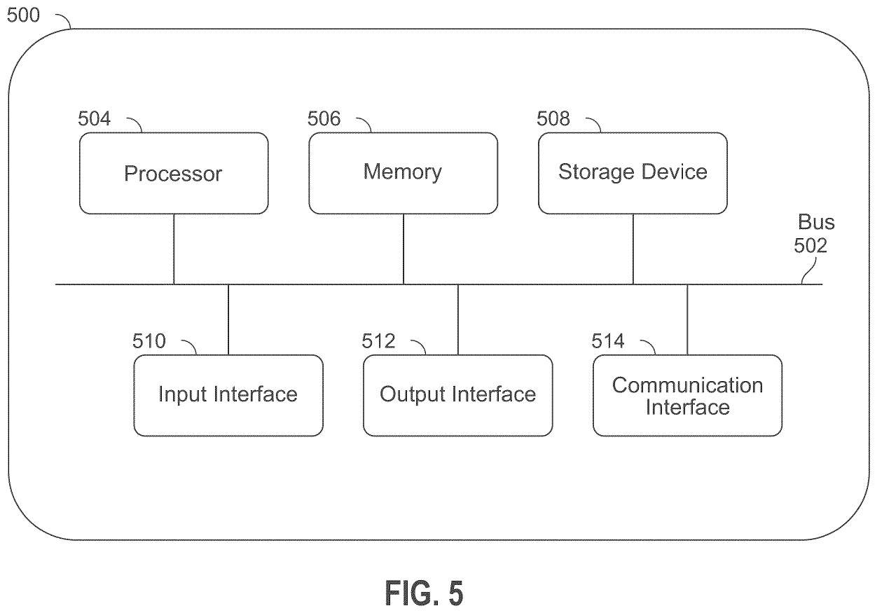

FIG. 5 is a block diagram illustrating an example architecture of a computing device 500 used to provide computational functionalities associated with described algorithms, methods, functions, processes, flows, and procedures. Other architectures are possible, including architectures with more or fewer components. The computing device can be implemented as the computing device 102 of FIG. 1, 2A, 2B, 2C, or 2D, or the computing device 320 of FIG. 3A or 3B. The computing device 500 includes processor 504, memory 506, storage component 508, input interface 510, output interface 512, communication interface 514, and bus 502.

Bus 502 includes a component that permits communication among the components of the computing device 500. In some embodiments, processor 504 is implemented in hardware, software, or a combination of hardware and software. In some examples, processor 504 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 506 includes random access memory (RAM), read-only memory (ROM), and/or another type of dynamic and/or static storage device (e.g., flash memory, magnetic memory, optical memory, and/or the like) that stores data and/or instructions for use by processor 504.

Storage component 508 stores data and/or software related to the operation and use of the computing device 500. In some examples, storage component 508 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 510 includes a component that permits the computing device 500 to receive information, such as via user input (e.g., a touchscreen display, a keyboard, a keypad, a mouse, a button, a switch, a microphone, a camera, and/or the like). Additionally or alternatively, in some embodiments input interface 510 includes a sensor that senses information (e.g., a global positioning system (GPS) receiver, an accelerometer, a gyroscope, an actuator, and/or the like). Output interface 512 includes a component that provides output information from the computing device 500 (e.g., a display, a speaker, one or more light-emitting diodes (LEDs), and/or the like).

In some embodiments, communication interface 514 includes a transceiver-like component (e.g., a transceiver, a separate receiver and transmitter, and/or the like) that permits the computing device 500 to communicate with other devices via a wired connection, a wireless connection, or a combination of wired and wireless connections. In some examples, communication interface 514 permits the computing device 500 to receive information from another device and/or provide information to another device. In some examples, communication interface 514 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 500 performs one or more processes described herein. The computing device 500 performs these processes based on processor 504 executing software instructions stored by a computer-readable medium, such as memory 506 and/or storage component 508. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 506 and/or storage component 508 from another computer-readable medium or another device via communication interface 514. When executed, software instructions stored in memory 506 and/or storage component 508 cause processor 504 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 506 and/or storage component 508 includes data storage or at least one data structure (e.g., a database and/or the like). The computing device 500 is capable of receiving information from, storing information in, communicating information to, or searching information stored in the data storage or the at least one data structure in memory 506 or storage component 508. In some examples, the information includes network data, input data, output data, or any combination thereof.

In some embodiments, the computing device 500 is configured to execute software instructions that are either stored in memory 506 and/or in the memory of another device (e.g., another device that is the same as or similar to the computing device 500). As used herein, the term “module” refers to at least one instruction stored in memory 506 and/or in the memory of another device that, when executed by processor 504 and/or by a processor of another device (e.g., another device that is the same as or similar to the computing device 500) cause the computing device 500 (e.g., at least one component of the computing device 500) to perform one or more processes described herein. In some embodiments, a module is implemented in software, firmware, hardware, and/or the like.

The number and arrangement of components illustrated in FIG. 5 are provided as an example. In some embodiments, the computing device 500 can include additional components, fewer components, different components, or differently arranged components than those illustrated in FIG. 5. Additionally or alternatively, a set of components (e.g., one or more components) of the computing device 500 can perform one or more functions described as being performed by another component or another set of components of the computing device 500.

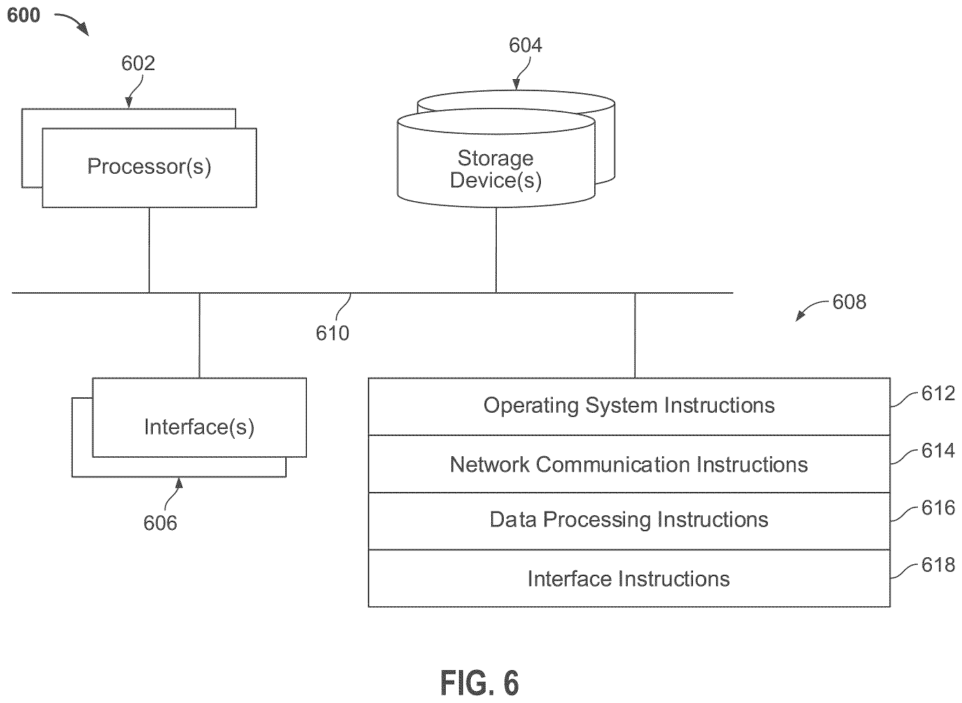

FIG. 6 illustrates an example architecture 600 of a computing system used to provide computational functionalities associated with described algorithms, methods, functions, processes, flows, and procedures. The computing system can be implemented as the computing system 100 of FIG. 1, the computing system 300a of FIG. 3A, or the computing system 300b of FIG. 3B. Other architectures are possible, including architectures with more or fewer components.

In some implementations, architecture 600 includes one or more processor(s) 602 (e.g., dual-core Intel® Xeon® Processors), one or more network interface(s) 606, one or more storage device(s) 604 (e.g., hard disk, optical disk, flash memory) and one or more computer-readable medium(s) 608 (e.g., hard disk, optical disk, flash memory, etc.). These components can exchange communications and data over one or more communication channel(s) 610 (e.g., buses), which can utilize various hardware and software for facilitating the transfer of data and control signals between components.

The term “computer-readable medium” refers to any medium that participates in providing instructions to the processor(s) 602 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 608 can further include instructions 612 for an operating system (e.g., Mac OS® server, Windows® NT server, Linux Server), instructions 614 for network communications module, data processing instructions 616, and interface instructions 618.

Operating systems can be multi-user, multiprocessing, multitasking, multithreading, real time, etc. Operating system performs basic tasks, including but not limited to: recognizing input from and providing output to devices 602, 604, 606 and 608; keeping track and managing files and directories on computer-readable medium(s) 608 (e.g., memory or a storage device); controlling peripheral devices; and managing traffic on the one or more communication channel(s) 610. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 616 include server-side or backend software for implementing the server-side operations. Interface instructions 618 includes software for implementing a web server and/or portal for sending and receiving data to and from user side computing devices and service side computing devices.

Architecture 600 can be implemented by a cloud computing system and can be included in any computer device, including one or more server computers in a local or distributed network each having one or more processing cores. Architecture 600 can be implemented in a parallel processing or peer-to-peer infrastructure or on a single device with one or more processors. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or, A and B.” As used herein, the term “and/or” as used herein refers to and encompasses any and all possible combinations of one or more of the associated listed terms. For example, the term “A and/or B” means that either option A, option B, or both options A and B are possible, where A and B may be singular or plural.

As used herein, the term “about” or “approximately” can allow for a degree of variability in a value or range, for example, within 10%, within 5%, or within 1% of a stated value or of a stated limit of a range. As used herein, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

In addition, the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The breadth and scope of the present disclosure should not be limited by any of the above-described exemplary implementations, but should be defined only in accordance with the following claims and their equivalents.

1. A device, comprising:
one or more connectors configurable to connect one or more peripheral devices that have one or more corresponding power requirements;
a power protection circuit configured to provide overcurrent protection to a peripheral device that is connected to the device; and
a resistance circuit connected to the power protection circuit, wherein the resistance circuit is configured to provide to the power protection circuit an adjustable resistance based on one or more sense signals from the one or more connectors,
wherein the one or more sense signals are based on a connection status between the one or more connectors and the peripheral device, and the one or more sense signals indicate a corresponding power requirement of the peripheral device, and
wherein the power protection circuit is configured to stop providing power to the peripheral device based on the adjustable resistance and a sensed current associated with the peripheral device.

2. The device of claim 1, wherein the power protection circuit is configured to:
perform a comparison between a first voltage determined based on the sensed current and a constant resistor and a second voltage determined based on the adjustable resistance and a constant current; and
determine to stop providing the power to the peripheral device based on a result of the comparison.

3. The device of claim 2, wherein the power protection circuit comprises a comparator and a power switch,
wherein the power switch comprises an input configured to be controlled by an output of the comparator and an output coupled to the peripheral device, and
wherein the power protection circuit is configured to:
determine, using the comparator, whether the first voltage is greater than the second voltage;
in response to determining that the first voltage is greater than the second voltage, turn off the power switch, causing to stop providing the power to the peripheral device; and
in response to determining that the first voltage is no greater than the second voltage, turn on the power switch, causing to provide the power to the peripheral device.

4. The device of claim 3, wherein the power protection circuit further comprises a control transistor having a first terminal coupled to the input of the power switch, a second terminal coupled to a ground reference voltage, and a gate terminal coupled to the output of the comparator, and
wherein the control transistor is configured to be turned on in response to the first voltage being greater than the second voltage, causing to turn off the power switch.

5. The device of claim 1, wherein the power protection circuit comprises a control logic circuit configured to generate the sensed current based on at least one of a current in the peripheral device, a type of the peripheral device, or the power requirement of the peripheral device.

6. The device of claim 1, wherein the resistance circuit comprises:
a plurality of resistors each coupled between an input of the power protection circuit and a ground reference voltage, wherein an output of the power protection circuit is coupled to the peripheral device and the one or more connectors; and
one or more transistors, wherein each transistor of the one or more transistors is coupled in series with a respective resistor of the plurality of resistors between the input of the power protection circuit and the ground reference voltage, and configured to be turned on or off based on at least a corresponding sense signal of the one or more sense signals from the one or more connectors.

7. The device of claim 6, wherein the peripheral device is connected with each of the one or more connectors, causing each of the one or more sense signals to have a lower voltage level to turn off the one or more transistors in the resistance circuit, such that the adjustable resistance for the peripheral device is based on at least one remaining resistor in the resistance circuit, independent from one or more resistors coupled in series with the one or more transistors.

8. The device of claim 7, wherein the peripheral device comprises power pins coupled to pins of an interface of the device that are coupled to the output of the power protection circuit, the interface being different from the one or more connectors, and
wherein the device is configured to provide a corresponding power to the peripheral device through the power pins and the one or more connectors.

9. The device of claim 6, wherein the peripheral device is disconnected from at least one of the one or more connectors, causing at least one sense signal of the one or more sense signals to have a higher voltage level to turn on at least one corresponding transistor in the resistance circuit, such that the adjustable resistance for the peripheral device is based on at least one resistor coupled in series with the at least one corresponding transistor.

10. The device of claim 6, wherein the peripheral device is disconnected from each of the one or more connectors, causing the one or more sense signals to have a higher voltage level to turn on the one or more transistors, such that the adjustable resistance for the peripheral device is based on at least one or more resistors coupled in series with the one or more transistors.

11. The device of claim 6, wherein the one or more connectors comprise:
a first connector having at least one first node configured to provide at least one first sense signal, and
a second connector having at least one second node configured to provide at least one second sense signal,
wherein each node of the at least one first node and the at least one second node is coupled to a corresponding transistor of the one or more transistors and configured to provide a respective sense signal to the corresponding transistor.

12. The device of claim 11, further comprising a logic gate having inputs coupled to at least two nodes of the at least one first node and the at least one second node and an output coupled to a particular transistor of the one or more transistors.

13. The device of claim 11, further comprising a control logic coupled between the one or more connectors and the resistance circuit and configured to provide the one or more sense signals respectively to the one or more transistors.

14. The device of claim 11, wherein the peripheral device comprises:
power pins coupled to the output of the power protection circuit.

15. The device of claim 14, wherein the peripheral device further comprises:
a first power connector configurable to connect to the first connector of the one or more connectors.

16. The device of claim 15, wherein the peripheral device further comprises a second power connector configurable to connect to the second connector of the one or more connectors.

17. The device of claim 11, wherein the peripheral device further comprises:
power pins coupled to at least one of the first connector or the second connector.

18. The device of claim 7, wherein a number of the plurality of resistors is greater than a number of the one or more transistors.

19. A system, comprising:
a host device; and
a peripheral device,
wherein the host device comprises:
one or more connectors configurable to connect one or more peripheral devices that have one or more corresponding power requirements;
a power protection circuit configured to provide overcurrent protection to the peripheral device that is connected to the host device; and
a resistance circuit connected to the power protection circuit, wherein the resistance circuit is configured to provide to the power protection circuit an adjustable resistance based on one or more sense signals from the one or more connectors,
wherein the one or more sense signals are based on a connection status between the one or more connectors and the peripheral device, and the one or more sense signals indicate a corresponding power requirement of the peripheral device, and
wherein the power protection circuit is configured to stop providing power to the peripheral device based on the adjustable resistance and a sensed current associated with the peripheral device.

20. A method, comprising:
determining a sensed current associated with a peripheral device coupled to an output of a power protection circuit;
comparing a first voltage based on the sensed current and a second voltage based on an adjustable resistance of a resistance circuit to generate a comparison result, wherein the resistance circuit is coupled to an input of the power protection circuit; and
determining whether to stop providing power to the peripheral device based on the comparison result,
wherein the adjustable resistance is based on one or more sense signals from one or more connectors coupled to the output of the power protection circuit, wherein the one or more connectors are configurable to be connected to the peripheral device according to a power requirement of the peripheral device, and wherein the one or more sense signals are based on a connection status between the one or more connectors and the peripheral device, and indicate the power requirement of the peripheral device.
